(19) United States
(12) Patent Application Publication
(10) Pub. No.: US 2025/0308082 A1
(43) Pub. Date: Oct. 2, 2025

(54) COMPOSITIONAL TEXT-TO-IMAGE GENERATION WITH DENSE BLOB REPRESENTATIONS

(71) Applicant: NVIDIA Corporation, Santa Clara, CA (US)

(72) Inventors: Weili Nie, Sunnyvale, CA (US); Sifei Liu, Santa Clara, CA (US); Morteza Mardani Korani, San Jose, CA (US); Chao Liu, Santa Clara, CA (US); Benjamin David Eckart, Pittsburgh, PA (US); Arash Vahdat, Mountain View, CA (US)

(21) Appl. No.: 18/889,975

(22) Filed: Sep. 19, 2024

Related U.S. Application Data
(60) Provisional application No. 63/571,043, filed on Mar. 28, 2024.

(51) Int. Cl. G06T 11/00

(52) U.S. Cl. CPC G06T 11/00

(57) ABSTRACT

Systems and methods are disclosed that generate dense blob representations such as blob parameters and blob descriptions, and use the dense blob representations to generate images. For example, embodiments of the present disclosure may decompose a scene into visual primitives (e.g., dense blob representations) and based on the blob representations, embodiments of the present disclosure develop a blob-grounded text-to-image diffusion model (BlobGEN) for compositional generation. For example, in some embodiments, a new masked cross-attention module may be introduced to disentangle the fusion between blob representations and visual features. In some embodiments, to leverage the compositionality of large language models (LLMs), a new in-context learning approach may be introduced to generate blob representations from text prompts.

### CLAIM OF PRIORITY

This application claims the benefit of U.S. Provisional Application No. 63/571,043 (Attorney Docket No. 514778) titled “Compositional Text-to-Image Generation with Dense Blob Representations,” filed Mar. 28, 2024, the entire contents of which is incorporated herein by reference.

### BACKGROUND

Recent advances in text-to-image models enable the ability to generate realistic high-quality images. This rapid rise in quality has been driven by new training and sampling strategies, new network architectures, and internet-scale image-text paired data. Despite the progress, current large-scale text-to-image models struggle to follow complex prompts, sometimes misunderstanding the context and ignoring keywords. Thus, fine-grained controllability is an open problem.

To cope with these challenges, conventional techniques have attempted to condition text-to-image models on visual layouts. Since a text prompt may be vague in describing visual concepts (e.g., the precise location of an object), image generation models may face difficulty striking a balance between expressing the given information and hallucinating missing information. Additional grounding inputs may guide the generation process for better controllability. These layouts may be represented by bounding boxes, semantic maps, depths, and other modalities. Among them, semantic and depth maps may provide fine-grained information, but are not easy for users to construct and manipulate. On the other hand, bounding boxes may be user-friendly, but bounding boxes only provide coarse-grained information. As such, none of the existing visual layouts capture the fine-grained details of a scene and simultaneously may be easily constructed and manipulated by users. Accordingly, there is a need for addressing these issues and/or other issues associated with the prior art.

### SUMMARY

Embodiments of the present disclosure may use dense blob representations to generate images from text prompts. For instance, a user may provide a prompt to generate an image of two individuals performing an action (e.g., talking), and specifics about the two individuals (e.g., clothing of one of the individuals and/or a precise location of an object being held by the individual). Current large scale text-to-image models may perform adequately when taking simple prompts (e.g., generating an image of two individuals), but may struggle to follow complex prompts (e.g., specifics about the two individuals within the image), where the models tend to misunderstand context and ignore keywords in the prompt. To address these challenges, an attempt to condition the text-to-image models on visual layouts has been made. However, image generation models may have difficulty striking a balance between expressing the given information and hallucinating missing information due to the fact that the text prompt may be vague when describing visual concepts (e.g., the precise location of an object). Therefore, additional grounding inputs may be used to guide the generation process for better controllability. These layouts may be represented, for example, by bounding boxes, semantic maps, depth information, or other modalities. Among them, semantic maps and/or depth maps may provide fine-grained information, but they are not easy for users to construct and manipulate. On the other hand, bounding boxes are user-friendly but only provide coarse-grained information. None of the existing visual layouts capture the fine-grained details of a scene and simultaneously can be easily constructed and manipulated by users. Therefore, embodiments of the present disclosure generate dense blob representations such as blob parameters and blob descriptions, and use the dense blob representations to generate images.

In other words, existing text-to-image models struggle to follow complex text prompts, raising the need for extra grounding inputs for better controllability. As such, embodiments of the present disclosure may decompose a scene into visual primitives (e.g., dense blob representations) that include fine-grained details of the scene while being modular, human-interpretable, and easy-to-construct. Based on the blob representations, embodiments of the present disclosure develop a blob-grounded text-to-image diffusion model (BlobGEN) for compositional generation. For example, in some embodiments, a new masked cross-attention module may be introduced to disentangle the fusion between blob representations and visual features. In some embodiments, to leverage the compositionality of large language models (LLMs), a new in-context learning approach may be introduced to generate blob representations from text prompts.

In an embodiment, a computer-implemented method for using a blob-grounded text-to-image diffusion model to generate images is provided. The method includes obtaining a blob representation for an object to be generated within an output image. The blob representation comprises a blob parameter and blob description. The blob parameter indicates a plurality of variables that define an ellipse for the object and the blob description indicates a textual description of the object. The method further includes inputting the blob representation into the blob-grounded text-to-image diffusion model to generate the output image.

### BRIEF DESCRIPTION OF THE DRAWINGS

The present systems and methods for implementing semi-structured sparsity in LLMs are described in detail below with reference to the attached drawing figures, wherein:

FIG. 1A shows an image of a scene and a decomposition of the scene into blob representations, in accordance with one or more embodiments of the present disclosure.

FIG. 1B illustrates a block diagram of a general overview for generating dense blob representations and using the generated dense blob representations to train a blob-grounded text-to-image diffusion model, in accordance with one or more embodiments of the present disclosure.

FIG. 1C illustrates a block diagram showing a training process for training the blob-grounded text-to-image diffusion model, in accordance with one or more embodiments of the present disclosure.

FIG. 1D illustrates a block diagram showing interactions between a blob-grounded attention layer, blob representations, and a U-Net layer from a blob-grounded U-Net, in accordance with one or more embodiments of the present disclosure.

FIG. 2A illustrates a block diagram showing an inference phase that uses a trained blob-grounded text-to-image diffusion model to generate output images, in accordance with one or more embodiments of the present disclosure.

FIG. 2B shows a system prompt that is used to generate the blob parameters, in accordance with one or more embodiments of the present disclosure.

FIG. 2C shows a system prompt that is used to generate the blob descriptions, in accordance with one or more embodiments of the present disclosure.

FIG. 3 illustrates a flowchart of a method for using the blob-grounded text-to-image diffusion model to generate output images, in accordance with an embodiment.

FIG. 4 illustrates an example parallel processing unit suitable for use in implementing some embodiments of the present disclosure.

FIG. 5A is a conceptual diagram of a processing system implemented using the PPU of FIG. 4, suitable for use in implementing some embodiments of the present disclosure.

FIG. 5B illustrates an exemplary system in which the various architecture and/or functionality of the various previous embodiments may be implemented.

FIG. 5C illustrates components of an exemplary system that can be used to train and utilize machine learning, in at least one embodiment.

FIG. 6 illustrates an exemplary streaming system suitable for use in implementing some embodiments of the present disclosure.

### DETAILED DESCRIPTION

Embodiments of the present disclosure may describe and use a new type of visual layout, termed dense blob representations or blob representations, to serve as grounding inputs to guide text-to-image generation. The blob representations correspond to visual primitives (e.g., objects in a scene) and may be automatically extracted from a scene.

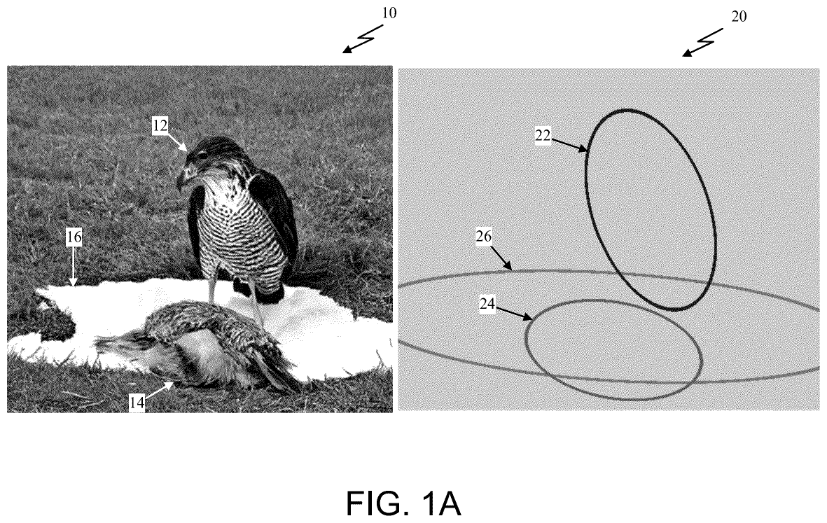

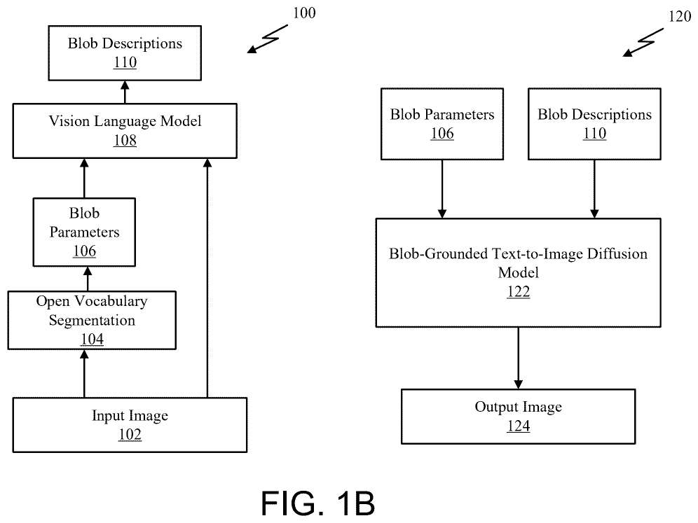

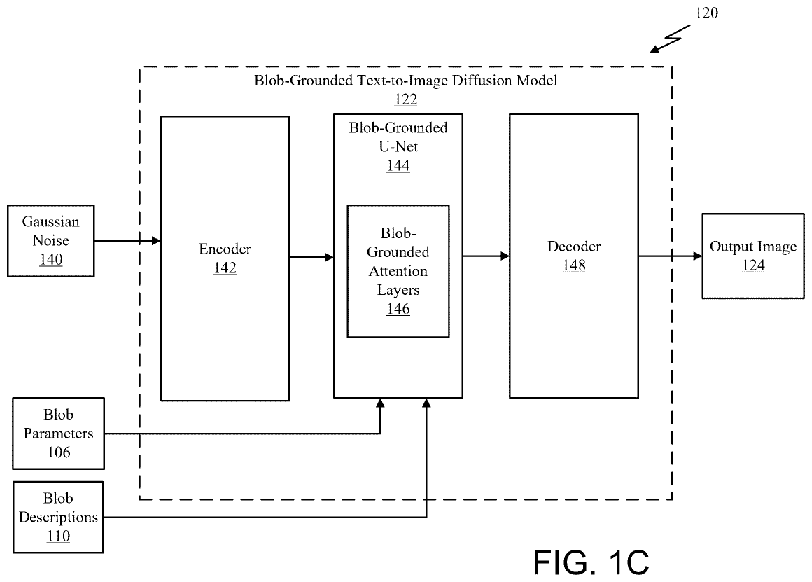

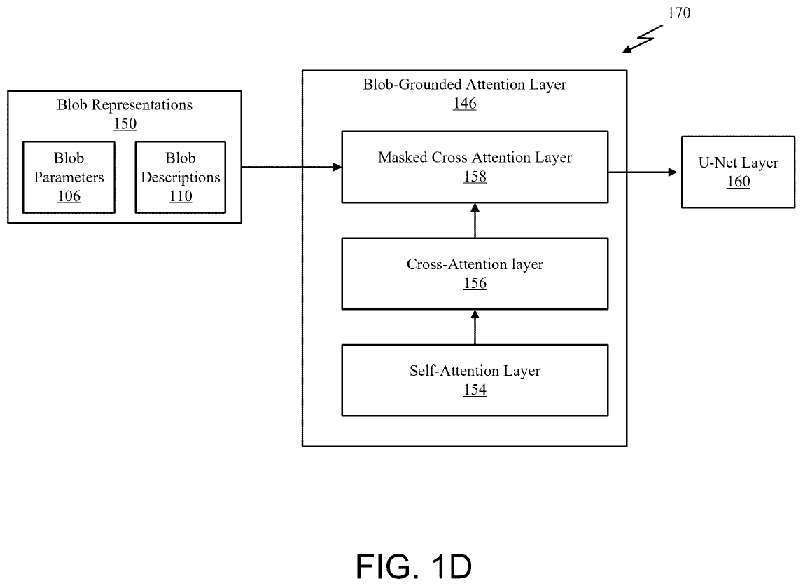

FIG. 1A shows an image of a scene 10 and a decomposition of the scene 20 into blob representations, in accordance with one or more embodiments of the present disclosure. For example, the image of the scene 10 may include objects such as two birds 12 and 14 as well as a patch of snow 16. Using one or more embodiments of the present disclosure, the image of the scene 10 may be decomposed into a decomposition of the scene 20, which includes blob representations 22, 24, and 26. For example, the object 12 (e.g., a first bird) may be decomposed into the blob representation 22, the object 14 (e.g., the second bird, which appears to lying on the ground) may be decomposed into the blob representation 24, and the object 16 (e.g., the patch of snow) may be decomposed into the blob representation 26. The decomposition of the objects 12-16 into the blob representations 22-26 will be described in further detail in FIG. 1B.

For example, a blob representation may include two components: 1) the blob parameter, which formulates a tilted ellipse to specify the object's position, size and orientation; and 2) the blob description, which is a rich text sentence that describes the object's appearance, style, and visual attributes. Referring to FIG. 1A, the blob representations 22-26 may represent one of the components of the blob representation—the blob parameter, which is shown as a tilted ellipse. The blob representation may largely preserve the fine-grained layout and semantic information of a scene (e.g., the image of the scene 10). Furthermore, since blob parameters and descriptions are both represented with structured texts, they may be easily constructed and manipulated by users.

As will be described below, embodiments of the present disclosure may develop (e.g., train) a blob-grounded text-to-image diffusion model, termed BlobGEN, that is built upon existing diffusion models and that uses blob representations (e.g., blob representations 22-26) as grounding inputs.

To disentangle the fusion between blob representations and visual features, a masked cross-attention module may be used that relates each blob to the corresponding visual feature solely in its local region. Furthermore, in some embodiments, a new in-context learning approach for LLMs is designed to generate dense blob representations from text prompts. By augmenting the blob-grounded text-to-image diffusion model with LLMs, embodiments of the present disclosure may leverage the visual understanding and compositional reasoning capabilities of LLMs to solve complex compositional image generation tasks. The blob-grounded text-to-image diffusion model may pave the way for a modular framework where images may be easily generated or manipulated by users and LLMs

The blob-grounded text-to-image diffusion model (e.g., BlobGEN) was tested extensively and was shown to achieve superior zero-shot generation quality and better layout guided controllability on MICROSOFT Common Objects in Context (MS-COCO). For instance, BlobGEN improves the zero-shot FID of base model from 10.40 to 8.61, and offers much better layout-guided controllability than conventional models as demonstrated by region-level Contrastive Language-Image Pretraining (CLIP) scores. By solely modifying a single blob representation while holding other blobs static, BlobGEN exhibits a strong local editing and object repositioning capability. With LLM augmentation, embodiments of the present disclosure were shown to excel in compositional generation tasks. For instance, using LLMs, embodiments of the present disclosure exhibit superior numerical and spatial correctness on compositional image generation benchmarks. Specifically, embodiments of the present disclosure were shown to outperform a conventional model by 5.7% and 1.4% for spatial and numerical accuracy on Numerical and Spatial Reasoning (NSR-1K) benchmarks.

As will be described in more detail below, embodiments of the present disclosure may decompose a scene into dense blob representations, each of which represents fine-grained details of a visual primitive in the scene. Additionally, and/or alternatively, embodiments of the present disclosure may further use BlobGEN, a blob-grounded modular text-to-image model with a new masked cross-attention module that takes blob representations as grounding inputs. Additionally, and/or alternatively, embodiments of the present disclosure may further augment BlobGEN with LLMs for compositional generation, by designing a new in-context learning approach for LLMs to infer blob representations from text prompts. Furthermore, as mentioned above, embodiments of the present disclosure were shown to achieve better zero-shot generation performance on MS-COCO, and have better numerical and spatial correctness in compositional benchmarks.

Initially, the image decomposition into blob representations will be first described below, and then the new generative framework that conditions on blob representations to generate images will be described. Further, the customized in-context learning procedure that prompts LLMs to generate blobs will be presented.

FIG. 1B illustrates a block diagram of a general overview for generating dense blob representations and using the generated dense blob representations to train a blob-grounded text-to-image diffusion model 122, in accordance with one or more embodiments of the present disclosure. The general overview includes a process 100 for generating the blob representations and a process 120 of using the generated dense blob representations to train a blob-grounded text-to-image diffusion model 122. For instance, based on an input image 102, the process 100 includes using an open vocabulary segmentation 104 and vision language model 108 to generate the blob representations including the blob parameters 106 and the blob descriptions 110. Then, using the blob parameters 106 and the blob descriptions 110, the process 120 includes using the blob-grounded text-to-image diffusion model 122 to generate an output image 124.

It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. Furthermore, persons of ordinary skill in the art will understand that any system that performs the operations of the open vocabulary segmentation 104, the vision language model 108, and the blob-grounded text-to-image diffusion model 122 is within the scope and spirit of embodiments of the present disclosure.

For example, process 100 may be used for generating the blob representations, which may satisfy two properties: 1) they include fine-grained details of the scene such that the original image can be semantically reconstructed, and 2) they are modular, human-interpretable and easy to construct or manipulate (e.g., users can create and edit an image efficiently). The blob representations include two components—the blob parameters 106 and the blob descriptions 110. The blob parameters 106 may specify a size, location, and orientation of the blob using a vector of five variables [cₓ, c_{y}, a, b, θ], where (cₓ, c_{y}) is the center point of the ellipse, a and b are the radii of its semi-major and semi-minor axes, and θ∈ (−π, π] is the orientation angle of the ellipse. In other words, the blob parameters 106 may represent the location and size of the object, and by including the orientation angle of the ellipse, the blob parameters 106 may additionally describe the orientation and pose of an object as well as more precisely describe the shape and size of the object. The blob descriptions 110 are text sentences that describe the visual appearance of an object, which complement the spatial layout information depicted by the blob parameter. For instance, the blob descriptions 110 may indicate objects within the input image 102 such as a mountain or a horse, and text sentences for the indicated objects such as “the horse is brown, on the right side of the image, and next to a picketed fence.”

To extract the blob parameters 106 from the input image 102, the input image 102 may be provided to an open vocabulary segmentation model 104. In some embodiments, the open vocabulary segmentation model 104 may include a standard segmentation model and an ellipse fitting optimization algorithm. In an embodiment, the standard segmentation model may be an open-vocabulary diffusion-based panoptic segmentation (ODISE) model, which is described in Xu et al., “Open-Vocabulary Panoptic Segmentation with Text-to-Image Diffusion Models” in Proceedings of the IEEE/CVF Conference on Computer Vision and Pattern Recognition, pp. 2955-2966 (2023) and is incorporated herein by reference. The input image 102 may be input into the standard segmentation model to generate instance segmentation maps, and the ellipse fitting optimization algorithm may use the instance segmentation maps to generate the blob parameters 106.

Following, the generated blob parameters 106 and the input image 102 may be used by the vision language model 108 to generate the blob descriptions 110. In some embodiments, the vision language model 108 may be a standard vision language model such as a Large Language and Vision Assistance (LLaVA), which is described in Liu et al., “Improved Baselines with Visual Instruction Tuning,” arXiv:2310.03744 (2023) and is incorporated herein by reference. For instance, as mentioned above, the blob parameters 106 may be determined based on the instance segmentation maps that are generated using a standard segmentation model (e.g., the ODISE model). Then, minimal bounding boxes that contain the blob ellipses indicated by the blob parameters 106 may be determined, and the minimal bounding boxes may be used to crop the image 102. The cropped images may be fed to the vision language model 108 (e.g., LLaVA) to generate the blob descriptions 110 (e.g., captions for each of the blobs).

As such, referring back to FIG. 1A, based on an input image 102 (e.g., the image of the scene 10 shown in FIG. 1A), process 100 may be used to decompose the input image 102 into blob representations. For example, the open vocabulary segmentation 104 may be used to determine the blob parameters 22-24 for each of the objects 12-16 from the image of the scene 10. Furthermore, the vision language model 108 may be used to generate blob descriptions 110 for each of the objects 12-16.

In other words, for image decomposition into blob representations, given an image (e.g., input image 102), embodiments of the present disclosure aim to extract visual primitives or object-level representations that satisfy two properties: 1) they include fine-grained details of the scene such that the original image may be semantically reconstructed in the maximum degree from them, and 2) they are modular, human-interpretable and easy to construct or manipulate, which means users may create and edit an image efficiently. To this end, a new type of visual layouts (e.g., dense blob representations) is described herein, and each blob representation may describe a single object in a scene. A blob representation may include two components: a blob parameter (e.g., blob parameters 106) and a blob description (e.g., blob descriptions 110).

For example, a blob parameter 106 specifies the size, location, and orientation of the blob (e.g., object from the image such as object 12 from the image 10) using the vector of five variables. Intuitively, similar to the functionality of bounding boxes, the blob parameter 106 may represent the location and size of an object. For example, referring to FIG. 1A, the blob parameter 22 may represent the location and size of the object 12.

On the other hand, due to the existence of the orientation angle θ, the visual layout depicted by a blob parameter 106 is more fine-grained than a bounding box: 1) the blob parameter 106 may additionally describe the orientation or pose of an object, and 2) the blob parameter 106 may more precisely describe the shape and size of an object, particularly those with an elongated shape and a large inclined angle.

A blob description 110 is a text sentence that describes the visual appearance of an object, complementing the spatial layout information depicted by the blob parameter 106. In some embodiments, a region-level synthetic caption extracted by a pre-trained image captioner (e.g., the vision language model 108) may be used as the blob description 110. In some embodiments, the blob description 110 might not only provide the category name, but also may capture the detailed visual features of an object, including the object's appearance (e.g., color, texture, material, and so on) and the spatial relationship of sub-parts within the object region (e.g., “a wooden chair with brown legs and soft seat”). For example, the input image 102 may be an image of chairs around a table. The blob parameters 106 may indicate positions, orientation, shape, size, and/or other details regarding the objects (e.g., the chairs and table). Each blob description 110 may indicate a category name (e.g., chair or table) associated with a blob parameter 106, and may further indicate additional details such as the color, texture, material, and/or spatial relationships of sub-parts of the object or spatial relationships between the object and other objects within the image 102 (e.g., “the chair is next to the table”).

Since the blob representations retain the fine-grained visual layouts and other detailed visual features of the original image 102, a diffusion model (e.g., the blob-grounded text-to-image diffusion model 122) may be able to faithfully recover the input image 102. Moreover, both blob parameters 106 and descriptions 110 are in the form of simple text inputs, and thus the blob parameters 106 and descriptions 110 may be easily constructed and manipulated by human users and even generated by LLMs, which is described in further detail below.

After generating the blob representations from the input image 102, process 120 is performed to train the blob-grounded text-to-image diffusion model 122. For instance, the blob-grounded text-to-image diffusion model 122 may be a modified diffusion model that generates the output image 124 using the blob parameters 106 and the blob descriptions 110. In other words, the blob parameters 106 and the blob descriptions 110 may be utilized by the blob-grounded text-to-image diffusion model 122 as grounding inputs to guide the generation process for generating the output image 124. A standard diffusion model loss may be determined based on comparing the output image 124 to the input image 102, and the loss may be used to train the blob-grounded text-to-image diffusion model 122. The architecture and training for the blob-grounded text-to-image diffusion model 122 will be described in further detail in FIG. 1C.

FIG. 1C illustrates a block diagram showing a training process 120 for training the blob-grounded text-to-image diffusion model 122, in accordance with one or more embodiments of the present disclosure. For instance, FIG. 1C shows a more detailed version of the training process 120 shown in FIG. 1B.

In an embodiment, the blob-grounded text-to-image diffusion model 122 may be a modification of a pre-trained text-to-image stable diffusion model such as the pre-trained text-to-image stable diffusion model described in Rombach et al., “High-resolution image synthesis with latent diffusion models” in Proceedings of the IEEE/CVF conference on computer vision and pattern recognition, pp. 10684-10695 (2022) and incorporated herein by reference. In particular, a stable diffusion model may be a diffusion model that includes an encoder and a decoder with a U-Net in-between the encoder and decoder. In the blob-grounded text-to-image diffusion model 122, the encoder 142 and the decoder 148 might not be modified from the standard stable diffusion model (e.g., the stable diffusion model described in Rombach et al.), but the U-Net 144 (e.g., the blob-grounded U-Net 144) may be modified to include one or more blob-grounded attention layers 146. The blob-grounded attention layers 146 may be provided the blob parameters 106 and the blob descriptions 110 as grounding input for the image generation. In operation, the Gaussian noise 140 may be provided to the encoder 142, and the encoder output is provided to the blob-grounded U-Net 144. Functionally, the blob-grounded U-Net 144 may be similar to a standard U-Net from the stable diffusion model except that it utilizes the blob parameters 106 and the blob descriptions 110. Then, the U-Net output is provided to the decoder 148, and the decoder 148 generates the output image 124 based on the U-Net output.

For example, existing text-to-image diffusion models often include convolutional and self-attention layers that operate on image features directly, and cross-attention layers that inject text conditioning into the network. BlobGEN (e.g., blob-grounded text-to-image diffusion model 122) may be built upon the pre-trained text-to-image Stable Diffusion model (e.g., the stable diffusion model described in Rombach et al.) except new cross-attention layers (e.g., the blob-grounded attention layers 146) may be introduced to incorporate blob grounding into the diffusion model 122. To retain the prior knowledge of pre-trained models for synthesizing high-quality images, embodiments of the present disclosure may freeze the weights from the pre-trained text-to-image Stable Diffusion model (e.g., the weights from the encoder 142, the decoder 148, and the blob-grounded U-Net except for the blob-grounded attention layers 146) and only train the newly added layers (e.g., the blob-grounded attention layers 146). Below, with reference to FIG. 1D, blob-grounded generation is described in further detail.

FIG. 1D illustrates a block diagram showing interactions between a blob-grounded attention layer 146, blob representations 150 (e.g., the blob parameters 106 and the blob descriptions 110), and a U-Net layer 160 from a blob-grounded U-Net 144 from FIG. 1C, in accordance with one or more embodiments of the present disclosure.

For example, in text-to-image generation, traditionally, attention layers such as a self-attention layer and a cross-attention layer may be utilized for image generation. For instance, a U-Net may include a plurality of U-Net layers and each U-Net layer may be connected to one or more attention layers. The attention layers may be provided text prompts and the output from the attention layers may be provided to the U-Net layer to guide the U-Net in generating an output that is converted by the decoder to the output image. In contrast, in addition to having a self-attention layer 154 and a cross-attention layer 156, embodiments of the present disclosure also include a masked cross attention layer 158 that guides the U-Net layer 160 in generation of the image using the blob representations 150, including the blob parameters 106 and the blob descriptions 110. In some embodiments, each U-Net layer from the blob-grounded U-Net 144 may include a blob-grounded attention layer 146 that comprises a masked cross attention layer 158. For example, the blob-grounded U-Net 144 may include a plurality of U-Net layers, and each U-Net layer may include a blob-grounded attention layer 146 that comprises a masked cross attention layer 158.

In some embodiments, prior to utilizing the blob representations 150, one or more encoders may be used to embed the blob parameters 106 and the blob descriptions 110. The encoders may be included within the masked cross attention layer 158 or may be separate from the masked cross attention layer 158. For the blob parameters 106, the encoder first encodes the orientation angle θ of the blob parameters 106 to the sine and cosine representation (sin θ, cos θ), and then obtains the blob parameter embedding based on performing a Fourier feature encoding. For the blob descriptions 110, a text encoder (e.g., a Contrastive Language-Image Pretraining (CLIP) text encoder) is used to obtain the blob sentence embeddings. Then, the blob sentence embeddings and the blob parameter embeddings are concatenated to generate a concatenated blob representation embedding using a multi-layer perception (MLP) layer.

In other words, the blob parameter 106 may be denoted as τ:=[cₓ, c_{y}, a, b, θ] and the blob description 110 may be denoted as s:=[s₁, . . . , S_{L}], where L is the text sentence length, s₁ is the first word in a sentence of the blob description 110, and S_{L} is the last word in a sentence of the blob description 110. For blob parameter T 106, first, embodiments of the present disclosure may encode orientation angle θ of the blob parameter 106 to the sine and cosine representation (sin θ, cos θ), and then obtain the blob parameter embedding e_{ι}=Fourier(\tilde{ι})∈ [symbol] ^{dι} where \tilde{ι}:=[cₓ, c_{y}, a, b, sin θ, cos θ] and Fourier(·) denotes the Fourier feature encoding, and dι represents the dimensions of the blob parameter embedding e_{ι}. The parameters of the blob parameter 106 (e.g., cₓ, c_{y}, a, b, sin θ, cos θ) are described above. For the blob description 110, the CLIP text encoder ƒ may be used to obtain the sentence embedding eₛ=ƒ(s): =[eₛ₁, . . . , e_{sL}]∈ [symbol] ^{L×d}^{ₛ}, where eₛ₁ is an embedding for the first word in the sentence of the blob description 110 and e_{sL} is an embedding for the last word in the sentence of the blob description 110. In some embodiments, the sentence embedding eₛ may be an embedding for more than one sentence (e.g., a short paragraph). For instance, using the CLIP text encoder, an embedding may be obtained for multiple sentences (e.g., multiple sentences that in their aggregate may have less than 77 total words). Before passing the blob sentence embedding to the network (e.g., to the masked cross attention layer 158 if the encoders are separate from the masked cross attention layer 158 or to the next component of the masked cross attention layer 158 if the encoders are within the masked cross attention layer 158), the two embeddings e_{ι}and eₛ are first concatenated. Thus, the final blob embedding for the blob representation e_{b} 150 is given by:

$${e}_{b} = MLP ( [ {\tilde{e}}_{{s}_{1}} , … , {\tilde{e}}_{{S}_{L}} ] ) ∈ {ℝ}^{L \times {d}_{b}}$$

where \tilde{e}ₛₗ [eₛₗ; e_{ι}]∈ [symbol] ^{d}^{ₛ}^{+d}^{ᵣ} for all l ∈{1, . . . , L} with [·;·] denoting a concatenation along the feature dimension, and MLP(·) represents an MLP layer. For the concatenation \tilde{e}ₛₗ:=[eₛₗ; e_{ι}], since eₛₗ is an embedding vector of dimension of dₛ and e_{ι} is an embedding vector of dimension of dᵣ, the concatenated vector \tilde{e}ₛₗ may have a dimension of dₛ+dᵣ. Also, MLP(·) is a multi-layer perceptron network that maps a tensor of size L×(dₛ+dᵣ) to a new tensor of size L×d_{b}.

Using the concatenated blob representations (e.g., the concatenated blob representation embeddings) and the output from the cross-attention layer 156, the masked cross attention layer 158 generates visual tokens that are provided to the U-Net layer 160 to guide in the generation of the output image 124. For instance, in standard cross-attention, every blob embedding may attend to every feature “pixel” (in the height (h)×width (w) plane) of the feature maps, which might not be desirable given that each blob embedding only convey information about the blob embedding's corresponding local region and the blob embedding's interaction with other regions may confuse the model. In contrast, the masked cross attention layer 158 utilizes an attention mask that masks the feature maps such that each blob embedding only attends to its local region. The attention mask may be obtained based on downsampling each blob's binary ellipse mask where the mask indicates a “1” if the pixel is within the blob's ellipse, and a “0” if the pixel is not within the blob's ellipse. Then, using the attention mask, the concatenated blob representations, and the output from the cross-attention layer 156, the visual tokens that are provided to the U-Net layer 160 may be generated. For example, similar to the standard cross-attention layer 156, a Query from a linear projection of visual features of an image may be obtained (e.g., from the output of the cross-attention layer 156), and a Key and a Value from two separate linear projections of blob embeddings (e.g., the blob representations 150) may be obtained. Then, assuming there are “N” blobs in the image (e.g., referring to FIG. 1A, “N” may be three blobs within the image 10 and associated with objects 12-16), the attention weight matrices (before Softmax) may be decomposed into “N” blob-specific attention weight matrices between the Query from visual features and each Key from an individual blob embedding from the blob representations 150. For each blob-specific attention weight matrix, where matrix's row dimension is h×w (height× width) and column dimension is L (text sentence length), the matrix's row may be set to negative infinity based on the attention mask at this pixel being “0”.

In other words, an image may include “N” blob embeddings, which may be denoted as {e_{b}⁽ⁿ⁾}ₙ₌₁ ^{N}. For example, the image 10 from FIG. 1A may include three blob embeddings e_{b}⁽¹⁾, e_{b}⁽²⁾, and e_{b}⁽³⁾ for the objects 12-16. Further, g∈ [symbol] ^{hw×d}^{_{g}} may be defined as the visual features of an image, where h and w represent the spatial size of the feature maps, and d_{g} denotes the feature dimension. If the query, key and value are denoted by q:=gW_{q} ∈ [symbol] ^{hw×d}^{_{g}}, k⁽ⁿ⁾ e_{b}⁽ⁿ⁾Wₖ⁽ⁿ⁾∈ [symbol] ^{L×d}^{_{g}}, and v⁽ⁿ⁾:=e_{b}⁽ⁿ⁾Wᵥ⁽ⁿ⁾∈ [symbol] ^{L×d}^{_{g}}, respectively, a standard cross-attention between visual features of an image g and the blob embeddings {e_{b}⁽ⁿ⁾}ₙ₌₁^{N} is

$$CA ( g , \{ {e}_{b}^{( i )} \} ) = σ ( \frac{{q [ {k}^{( 1 )} ; … ; {k}^{( N )} ]}^{T}}{\sqrt{{d}_{g}}} ) [ {v}^{( 1 )} ; … ; {v}^{( N )} ]$$

where [·;·] is a concatenation along the sequence dimension and σ(·) is the softmax function. In the above, W_{q}, Wₖ, and Wᵥ may be blob-specific attention weight matrics for the Query, Key, and Value. In the example from FIG. 1A, the standard cross-attention is shown below

$$CA ( g , \{ {e}_{b}^{( i )} \} ) = σ ( \frac{{q [ {k}^{( 1 )} ; {k}^{( 2 )} ; {k}^{( 3 )} ]}^{T}}{\sqrt{{d}_{g}}} ) [ {v}^{( 1 )} ; {v}^{( 2 )} ; {v}^{( 3 )} ]$$

where q is the image feature tensor by passing the image 10 to the network, k⁽¹⁾, k⁽²⁾, k⁽³⁾ are the keys that are associated with blobs 22, 24 and 26, and v⁽¹⁾, v⁽²⁾, v⁽³⁾ are the values that are associated with blobs 22, 24 and 26. Each key from a blob may freely interact with (or attend to) any part in the feature tensor through the tensor inner product within the Softmax function.

As shown above, in the standard cross-attention, every blob embedding attends to every feature “pixel” (in the h×w plane) of the feature maps. This is undesirable since each blob embedding only conveys information about its corresponding local region, and its interaction with other regions may confuse the diffusion model, leading to more text leakage and entanglement in generation.

To resolve this, embodiments of the present disclosure may use a masked cross attention layer 158 to mask the feature maps g such that each blob embedding only attends to its local region. For example, denote the attention mask for the i-th blob as m⁽ⁱ⁾∈ [symbol] ^{hw}. The attention mask for the i-th blob may be obtained by downsampling the i-th blob's binary ellipse mask where a pixel value is “1” if it is within the blob ellipse, and “0” otherwise. For instance, the attention mask for the object 12 may be and/or include a one dimensional matrix of size h multiplied by w (e.g., each pixel within the image 10 may be associated with an entry within the attention mask matrix). Then, based on downsampling, for pixel values that are within the blob ellipse of the object 12 (e.g., within the blob ellipse shown by the blob parameter 22), the attention mask for the object 12 would include a pixel value of “1”. Otherwise, the attention mask for the object 12 would include a pixel value of “0”.

Accordingly, the masked cross-attention used by the masked cross attention layer 158 may be defined as

$${CA}_{m} ( g , \{ {e}_{b}^{( i )} , {m}^{( i )} \} ) = σ ( \frac{{[ {a}^{( 1 )} ; … ; {a}^{( N )} ]}^{T}}{\sqrt{{d}_{g}}} ) [ {v}^{( 1 )} ; … ; {v}^{( N )} ]$$

where the i^{th} attention weight for the j^{th} location is:

$${a}_{j}^{( i )} = \{ \begin{matrix}{q}_{j} {k}^{( i ) T} & if {m}_{j}^{( i )} = 1 \\ - ∞ & otherwise\end{matrix} for j ∈ \{ 1 , 2 , … , hw \} .$$

Thus, for image 10, the masked cross-attention is

$${CA}_{m} ( g , \{ {e}_{b}^{( i )} , {m}^{( i )} \} ) = σ ( \frac{[ {a}^{( 1 )} ; {a}^{( 2 )} ; {a}^{( 3 )} ]}{\sqrt{{d}_{g}}} ) [ {v}^{( 1 )} ; {v}^{( 2 )} ; {v}^{( 3 )} ]$$

and the difference between the masked cross-attention and the standard cross-attention is within the numerator of the softmax function (e.g., the Key and Query), which utilizes the attention mask that is described above. For example, for the object 12, which is associated with the blob parameter 22, the attention weight matrix aⱼ⁽¹⁾ may be represented as

$${a}_{j}^{( i )} = \{ \begin{matrix}{q}_{j} {k}^{( i ) T} & if {m}_{j}^{( i )} = 1 \\ - ∞ & otherwise\end{matrix} for j ∈ \{ 1 , 2 , … , hw \} .$$

where a standard attention weight is obtained based on the attention mask indicating a pixel value of “1” for the pixel (e.g., the pixel is within the ellipse of the blob parameter 22), but the attention weight is set to negative infinity based on the attention mask indicating a pixel value of “0” for the pixel (e.g., the pixel is outside the ellipse of the blob parameter 22). Thus, for the example from FIG. 1A, using the attention mask, the blob parameters 22 and 26 may both attend to pixels that are within the overlapping region (e.g., the region where blob parameters 22 and 26 overlap each other). Further, outside of the overlapping region, the blob parameters 22 and 26 may further attend to their own regions (e.g., the region within the blob parameter 22 that is not overlapping with the blob parameter 26). Additionally, the blob parameters 22 and 26 might not attend to other regions within the image 10 such as the region that is within blob parameter 24, but not within blob parameter 26.

With this masking design, blob representations and local visual features are well aligned in an explicit manner. Therefore, the blob grounding process may be more modular and independent across different object regions, and the blob-grounded text-to-image diffusion model 122 may be more disentangled in generation.

In some embodiments, for the training process 120, the blob-grounded text-to-image diffusion model 122 may begin as a pre-trained stable diffusion model. Then, the weights of the pre-trained stable diffusion model may be frozen, and only the newly added layers (e.g., the masked cross attention layer 158) may be trained. Thus, the stable diffusion loss may be determined based on comparing the output image 124 and the input image 102, and the stable diffusion loss may be used to train only the weights from the masked cross attention layers 158.

In some embodiments, the masked cross-attention module (e.g., the blob-grounded attention layer 146 and/or the masked cross attention layer 158) may be added in a gated way, where a learnable scalar controls the information flow from the cross-attention branch (e.g., the cross-attention layer 156) for more stable training. In some embodiments, the gated self-attention module that is described in Li et al., “Open-set grounded text-to-image generation” in Proceedings of the IEEE/CVF Conference on Computer Vision and Pattern Recognition, pp. 22511-22521 (2023) and is incorporated herein by reference is also added, which shows a slight improvement in generation quality. In some embodiments, embodiments of the present disclosure might not make any changes to self-attention and convolutional layers (e.g., the self-attention layers 154), allowing information to propagate across different image regions for overall long-range correlations. For the image-level global captions, in some embodiments, synthetic image-level global captions may be used to train the blob-grounded text-to-image diffusion model 122 as global captions may work better than original real captions. In some embodiments, the original denoising score matching loss may be used to train only the new parameters (e.g., the weights from the masked cross attention layer 158). After training, the blob-grounded text-to-image diffusion model 122 may be used in the inference phase to generate images from the blob representations.

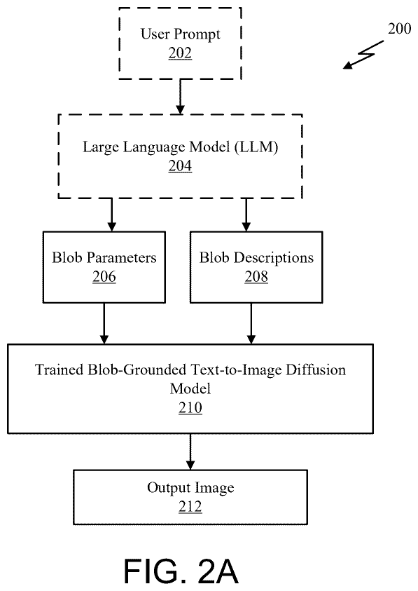

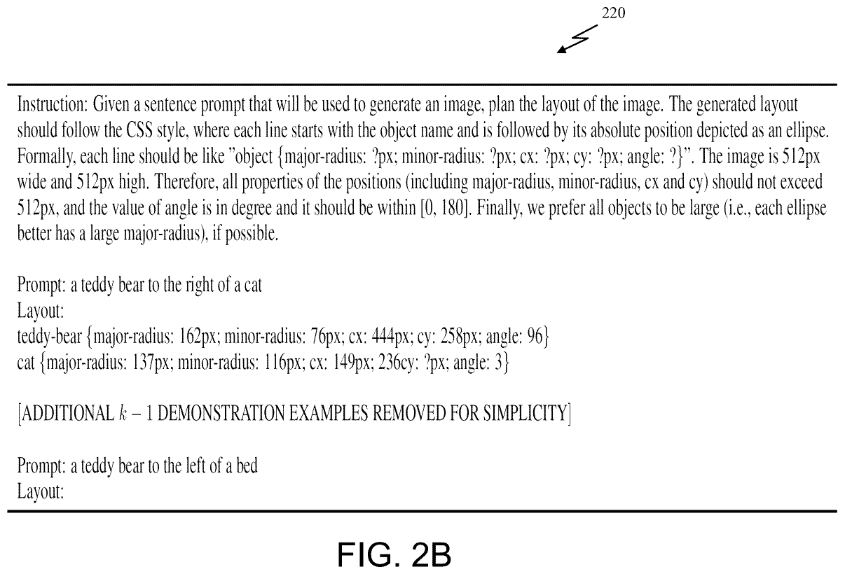

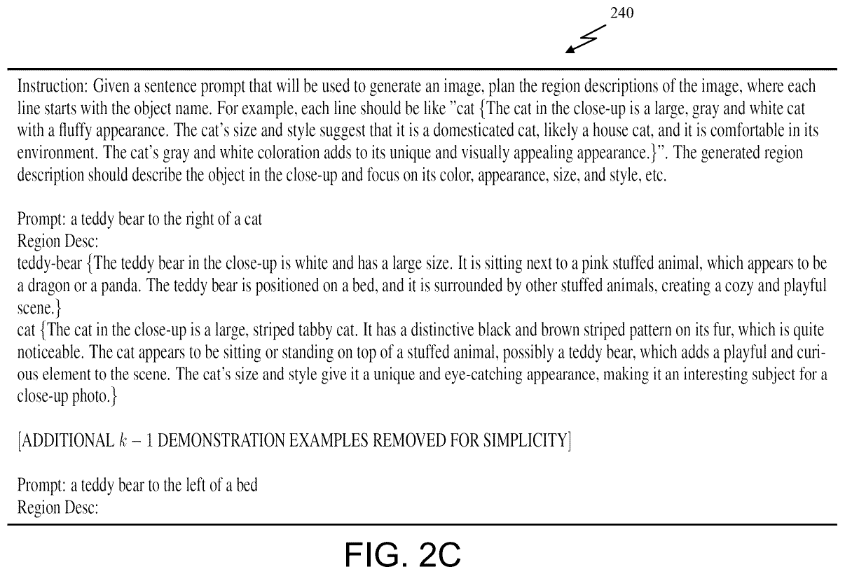

FIG. 2A illustrates a block diagram showing an inference phase 200 that uses a trained blob-grounded text-to-image diffusion model 210 to generate output images 212, in accordance with one or more embodiments of the present disclosure. The trained blob-grounded text-to-image diffusion model 210 may be the blob-grounded text-to-image diffusion model 122 after the blob-grounded text-to-image diffusion model 122 has been trained (e.g., based on using processes 100 and 120). As shown, the large language model (LLM) 204 and the user prompt 202 are denoted as dashed boxes to show that they are optional.

For example, in embodiments without the user prompt 202 and the LLM 204, a user may provide the blob parameters 206 and the blob descriptions 208 to the trained blob-grounded text-to-image diffusion model 210. Based on the inputs, the trained blob-grounded text-to-image diffusion model 210 generates the output image 212. Additionally, and/or alternatively, users may be able to manipulate either the blob parameters 206 and/or the blob descriptions 208 such as by adjusting one or more parameters from the blob parameters 206. Thus, based on manually adjusting the blob parameters 206 and/or the blob descriptions 208, the trained blob-grounded text-to-image diffusion model 210 may be able to account for the user manipulations and generate output images 212 that reflect the user manipulations. For instance, based on user input indicating to move the object from a person's right hand to left hand, the blob parameters 206 and/or the blob descriptions 208 may be obtained that indicate the user input. Then, the modified blob parameters 206 and/or the modified blob descriptions 208 may be utilized as grounding input for the trained blob-grounded text-to-image diffusion model 210, and the output image 212 may reflect the movement of the object from the person's right hand to left hand.

In some embodiments, the LLM 204 may be utilized to generate the blob parameters 206 and the blob descriptions 208 from the user prompt 202. Specifically, as described below, two separate in-context learned processes may be designed: one for generating blob parameters 206 and another for generating blob descriptions 208.

For instance, for generating the blob parameters 206, a compressed column storage (CCS) format may be adopted to represent blob parameters 206 such that LLMs 204 better understand their spatial meaning. Each generated layout in an in-context example starts with the category name, followed by a declaration section in the CSS style, which is “object {major-radius:?px; minor-radius: ?px; cₓ: ?px; c_{y}: ?px; angle: ?}”. The first four values are measured in pixel length, whereas the last value for angle is expressed in degree and normalized to be within [0, 18θ]. All values are rounded to integers. Next, top-k similar demonstration examples may be selected. The final prompt for LLMs 204 may include a system prompt that instructs the blob parameter generation, k demonstration examples, and the test prompt (e.g., a global caption).

In other words, initially, one or more system prompts may be generated (e.g., based on task design) and then provided to the LLM 204 to instruct the LLM 204 on how to generate the blob parameters 206 and the blob descriptions 208. The system prompt may indicate an instruction and demonstration examples. For instance, FIG. 2B shows a system prompt 220 that is used to generate the blob parameters 206, in accordance with one or more embodiments of the present disclosure. For instance, the system prompt 220 shows a set of instructions demonstration examples (e.g., prompt and layout), and a text prompt of a real example to show the system prompt 220 (e.g., “a teddy bear to the left of a bed”).

For example, for a system prompt to generate the blob parameters 206, the instruction set (e.g., the instructions shown in system prompt 220) may indicate that based on a sentence prompt that will be used to generate an image, the layout of the image may be planned. Specifically, the layout of the image may follow CCS style starting with an object name and followed by its position depicted as an ellipse (e.g., the five parameters of the blob parameters 206 described above). The system prompt (e.g., system prompt 220) may further include demonstration examples that may indicate example prompts as well as example layouts (e.g., examples of the five parameters for the blob parameters 206). After providing the system prompt (e.g., system prompt 220) to instruct the LLM 204, the LLM 204 may be provided a user prompt 202, and generate blob parameters 206 based on the user prompt 202.

Turning to the generation of blob descriptions 208, blob descriptions 208 may be less structured as they are essentially a list of text sentences. Thus, the CSS format might not be used to generate the blob descriptions 208, but the category name may still be used as a separator between blobs for the ease of LLM generation. Thus, each generated blob description 208 in an in-context example is formatted as “object {text sentence}”. The same method to select top-k demonstration examples and construct the final prompt as described above for the blob parameters 206 may be used, which includes a system prompt that instructs the blob description generation, k demonstration examples, and the test prompt.

In other words, to generate the blob descriptions 208, another system prompt may be generated and provided to the LLM 204. FIG. 2C shows a system prompt 240 that is used to generate the blob descriptions 208, in accordance with one or more embodiments of the present disclosure. For instance, the system prompt 240 shows a set of instructions demonstration examples (e.g., prompt and layout), and a text prompt of a real example to show the system prompt 240 (e.g., “a teddy bear to the left of a bed”).

The system prompt for the blob descriptions 208 (e.g., the system prompt 240) does not use the CCS format, but instead uses the category name as a separator between blobs for the ease of LLM generation. For instance, the instruction set for the blob descriptions 208 (e.g., the system prompt 240) may indicate that given a sentence prompt that will be used to generate an image, plan the region descriptions of the image where each line starts with the object name. Further, the system prompt (e.g., the system prompt 240) may include demonstration examples. After providing the system prompt (e.g., the system prompt 240) to instruct the LLM 204, the LLM 204 may be provided a user prompt 202, and generate blob descriptions 208 based on the user prompt 202.

In some examples, embodiments of the present disclosure may use image editing. For example, various image editing tasks (e.g., image editing on MS-COCO) may be performed by modifying the blob parameter for object repositioning, or modifying the blob description for local object/attribute manipulation. Thus, embodiments of the present disclosure may enable various image editing capabilities, including changing the fine-grained orientation of an object that conventional techniques might not be able to accomplish.

In some instances, embodiments of the present disclosure may use numerical and spatial reasoning. For example, embodiments of the present disclosure might not only generate images with better spatial and numerical correctness, but also may have better visual quality with less “copy-and-paste” effect.

Among other benefits and advantages, embodiments of the present disclosure provide a process 100 to decompose an input image 102 into blob parameters 106 to describe the location and size of objects within the image 102 and blob descriptions 110 to describe the visual appearance of the objects. Additionally, and/or alternatively, embodiments of the present disclosure train a blob-grounded text-to-image diffusion model 122 that comprises masked cross attention layers 158. Additionally, and/or alternatively, embodiments of the present disclosure use LLMs 204 to generate blob parameters 206 and blob descriptions 208 from user prompts 202, and then using the blob parameters 206 and blob descriptions 208 as well as a trained blob-grounded text-to-image diffusion model 210 to generate images 212.

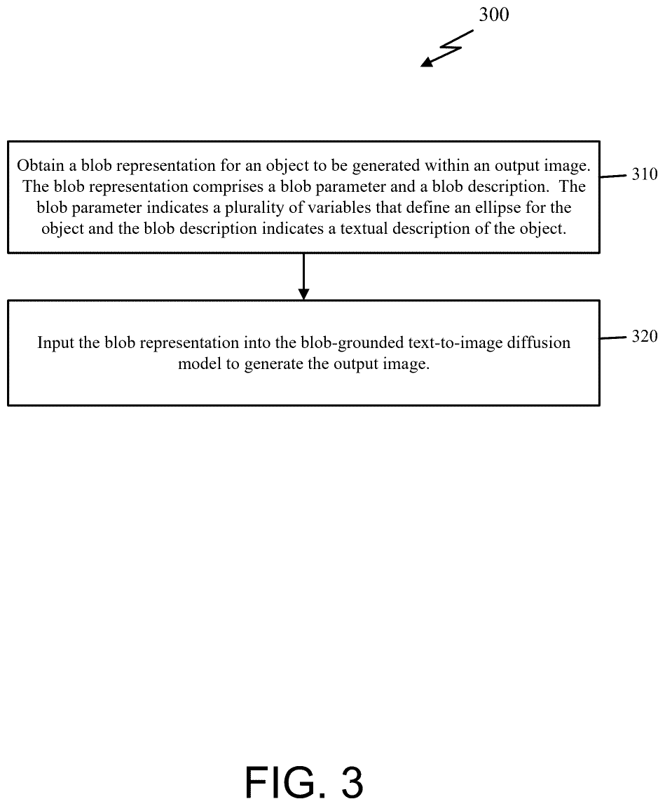

FIG. 3 illustrates a flowchart of a method 300 for using the blob-grounded text-to-image diffusion model to generate output images, in accordance with an embodiment. Each block of method 300, described herein, comprises a computing process that may be performed using any combination of hardware, firmware, and/or software. For instance, various functions may be carried out by a processor executing instructions stored in memory. The method 300 may also be embodied as computer-usable instructions stored on computer storage media. The method 300 may be provided by a standalone application, a service or hosted service (standalone or in combination with another hosted service), or a plug-in to another product, to name a few. In addition, method 300 is described, by way of example, with respect to the blob-grounded text-to-image diffusion model 122 of FIG. 1B and the trained blob-grounded text-to-image diffusion model 210 of FIG. 2A. However, the method 300 may additionally or alternatively be executed by any one system, or any combination of systems, including, but not limited to, those described herein. Furthermore, persons of ordinary skill in the art will understand that any system that performs method 300 is within the scope and spirit of embodiments of the present disclosure.

At step 310, a blob representation for an object to be generated within an output image is obtained. The blob representation comprises a blob parameter and a blob description. The blob parameter indicates a plurality of variables that define an ellipse for the object and the blob description indicates a textual description of the object. In an embodiment, the method 300 further comprises obtaining a request to generate the output image, wherein the request comprises a user prompt. And, obtaining the blob representation comprises: generating the blob parameter and the blob description based on inputting the user prompt into one or more large language models (LLMs).

In an embodiment, generating the blob parameter and the blob description based on inputting the user prompt into the one or more LLMs comprises: generating a first system prompt for the blob parameter using the user prompt; generating a second system prompt for the blob description using the user prompt; and providing the first system prompt and the second system prompt to the one or more LLMs to generate the blob parameter and the blob description.

At step 320, the blob representation is input into a blob-grounded text-to-image diffusion model (e.g., the trained blob-grounded text-to-image diffusion model 210) to generate the output image. In an embodiment, the blob-grounded text-to-image diffusion model (e.g., the trained blob-grounded text-to-image diffusion model 210) is a modified stable diffusion model that comprises an encoder (e.g., encoder 142), a decoder (e.g., decoder 148), and a blob-grounded U-Net architecture (e.g., the blob-grounded U-Net 144) and the blob-grounded U-Net architecture comprises blob-grounded attention layers (e.g., blob-grounded attention layers 146) and a plurality of U-Net layers.

In an embodiment, each of the blob-grounded attention layers (e.g., blob-grounded attention layers 146) comprise a masked cross attention layer (e.g., masked cross attention layer 158) that is connected to a U-Net layer (e.g., U-Net Layer 160) of the plurality of U-Net layers and inputting the blob representation into the blob-grounded text-to-image diffusion model to generate the output image comprises: generating visual tokens based on providing a blob representation embedding to the masked cross attention layer (e.g., masked cross attention layer 158); and providing the generated visual tokens to the U-Net layer (e.g., the U-Net layer 160) to guide the U-Net layer in generating the output image.

In an embodiment, inputting the blob representation into the blob-grounded text-to-image diffusion model to generate the output image further comprises: performing a Fourier feature encoding to encode the blob parameter into a blob parameter embedding; inputting the blob description into a text encoder to generate a blob sentence embedding; and concatenating the blob parameter embedding and the blob sentence embedding to generate the blob representation embedding.

In an embodiment, inputting the blob representation into the blob-grounded text-to-image diffusion model to generate the output image further comprises: generating an attention mask that attends to a subset of a plurality of pixels based on the subset of the plurality of pixels being within a blob ellipse that is defined by the blob parameter. Further, generating the visual tokens comprises generating, by the masked cross attention layer, the visual tokens based on the blob representation embedding attending to only the subset of the plurality of pixels that are within the blob ellipse being defined by the blob parameter.

In an embodiment, prior to performing steps 310 and 320, the method 300 further comprises training the blob-grounded text-to-image diffusion model using training data comprising a training image and one or more training models. In an embodiment, training the blob-grounded text-to-image diffusion model comprises: inputting the training image into an open vocabulary segmentation model to generate one or more training blob parameters; inputting the one or more training blob parameters and the training image into a vision language model to generate one or more training blob descriptions; inputting the one or more training blob parameters and the one or more training blob descriptions into the blob-grounded text-to-image diffusion model to generate a training output image; and training the blob-grounded text-to-image diffusion model based on comparing the training output image with the training image.

In an embodiment, the open vocabulary segmentation model is an open-vocabulary diffusion-based panoptic segmentation (ODISE) model and inputting the training image into the open vocabulary segmentation model to generate the one or more training blob parameters comprises: inputting an embedding of the input image into the ODISE model to generate instance segmentation maps; and using an ellipse fitting optimization algorithm to generate the one or more training blob parameters from the instance segmentation maps. In an embodiment, the vision language model is a Large Language and Vision Assistance (LLaVA) model and each of the one or more training blob descriptions comprises captions that describe a training blob parameter from the one or more training blob parameters.

In an embodiment, at least one of steps 310 and 320 and/or the further steps described above for method 300 are performed on a server or in a data center to train the blob-grounded text-to-image diffusion model 122 and/or use the trained grounded text-to-image diffusion model 210 to generate the output image, and the output image is streamed to a user device. In an embodiment, at least one of steps 310 and 320 and/or the further steps described above for method 300 is performed within a cloud computing environment. In an embodiment, at least one of steps 310 and 320 and/or the further steps described above for method 300 is performed for training, testing, or certifying a neural network employed in a machine, robot, or autonomous vehicle. In an embodiment, at least one of steps 310 and 320 and/or the further steps described above for method 300 is performed on a virtual machine comprising a portion of a graphics processing unit.

In some examples, because existing text-to-image models may struggle to follow complex text prompts, which raises the need for extra grounding inputs for better controllability, embodiments of the present disclosure may generate dense blob representations such as blob parameters and blob descriptions, and use the dense blob representations as grounding inputs to generate images. For instance, embodiments of the present disclosure may first train a blob-grounded text-to-image diffusion model that accepts the blob representations as grounding inputs, and then use the trained blob-grounded text-to-image diffusion model to generate images. In some variations, embodiments of the present disclosure may decompose a scene into visual primitives (e.g., dense blob representations) that include fine-grained details of the scene while being modular, human-interpretable, and easy-to-construct. Based on the blob representations, embodiments of the present disclosure may develop (e.g., train) a blob-grounded text-to-image diffusion model for compositional generation. For example, in some embodiments, a new masked cross-attention module may be introduced to disentangle the fusion between blob representations and visual features. In some embodiments, after training and during the inference phase, based on a user prompt, LLMs may be used to generate the blob representations. Subsequently, the generated blob representations may be fed into the trained blob-grounded text-to-image diffusion model to generate images responsive to the user prompt.

### Parallel Processing Architecture

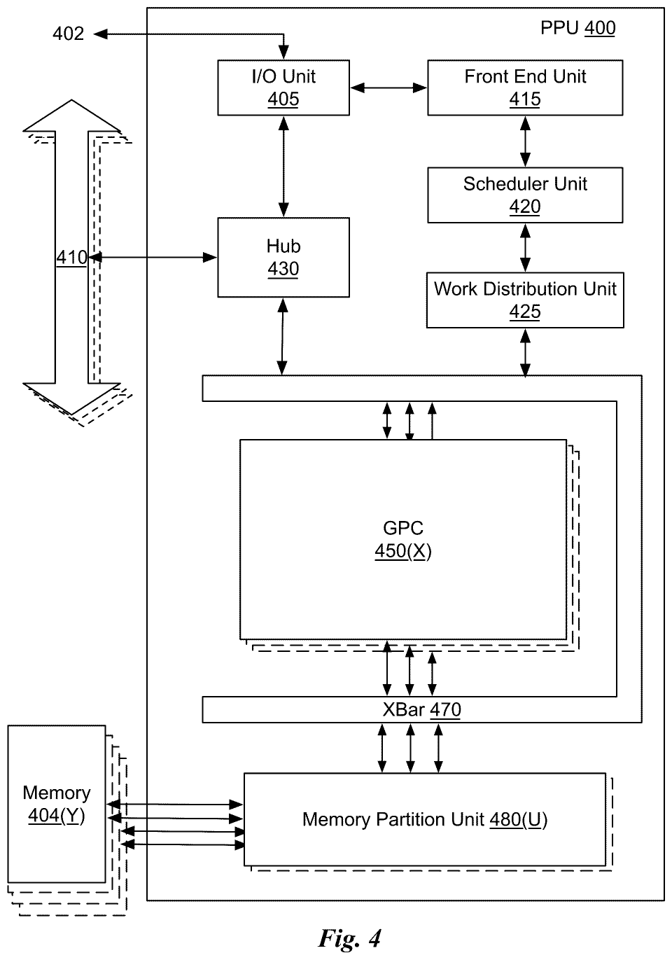

FIG. 4 illustrates a parallel processing unit (PPU) 400, in accordance with an embodiment. The PPU 400 may be used to generate dense blob representations such as blob parameters 106 and blob descriptions 110, and use the dense blob representations to generate images. In an embodiment, a processor such as the PPU 400 may be configured to train a blob-grounded text-to-image diffusion model 122 and use the trained blob-grounded text-to-image diffusion model 210 to generate an output image 212. The neural network model may be implemented as software instructions executed by the processor or, in other embodiments, the processor can include a matrix of hardware elements configured to process a set of inputs (e.g., electrical signals representing values) to generate a set of outputs, which can represent activations of the neural network model. In yet other embodiments, the neural network model can be implemented as a combination of software instructions and processing performed by a matrix of hardware elements. Implementing the neural network model can include determining a set of parameters for the neural network model through, e.g., supervised or unsupervised training of the neural network model as well as, or in the alternative, performing inference using the set of parameters to process novel sets of inputs.

In an embodiment, the PPU 400 is a multi-threaded processor that is implemented on one or more integrated circuit devices. The PPU 400 is a latency hiding architecture designed to process many threads in parallel. A thread (e.g., a thread of execution) is an instantiation of a set of instructions configured to be executed by the PPU 400. In an embodiment, the PPU 400 is a graphics processing unit (GPU) configured to implement a graphics rendering pipeline for processing three-dimensional (3D) graphics data in order to generate two-dimensional (2D) image data for display on a display device. In other embodiments, the PPU 400 may be utilized for performing general-purpose computations. While one exemplary parallel processor is provided herein for illustrative purposes, it should be strongly noted that such processor is set forth for illustrative purposes only, and that any processor may be employed to supplement and/or substitute for the same.

One or more PPUs 400 may be configured to accelerate thousands of High Performance Computing (HPC), data center, cloud computing, and machine learning applications. The PPU 400 may be configured to accelerate numerous deep learning systems and applications for autonomous vehicles, simulation, computational graphics such as ray or path tracing, deep learning, high-accuracy speech, image, and text recognition systems, intelligent video analytics, molecular simulations, drug discovery, disease diagnosis, weather forecasting, big data analytics, astronomy, molecular dynamics simulation, financial modeling, robotics, factory automation, real-time language translation, online search optimizations, and personalized user recommendations, and the like.

As shown in FIG. 4, the PPU 400 includes an Input/Output (I/O) unit 405, a front end unit 415, a scheduler unit 420, a work distribution unit 425, a hub 430, a crossbar (Xbar) 470, one or more general processing clusters (GPCs) 450, and one or more memory partition units 480. The PPU 400 may be connected to a host processor or other PPUs 400 via one or more high-speed NVLink 410 interconnect. The PPU 400 may be connected to a host processor or other peripheral devices via an interconnect 402. The PPU 400 may also be connected to a local memory 404 comprising a number of memory devices. In an embodiment, the local memory may comprise a number of dynamic random access memory (DRAM) devices. The DRAM devices may be configured as a high-bandwidth memory (HBM) subsystem, with multiple DRAM dies stacked within each device.

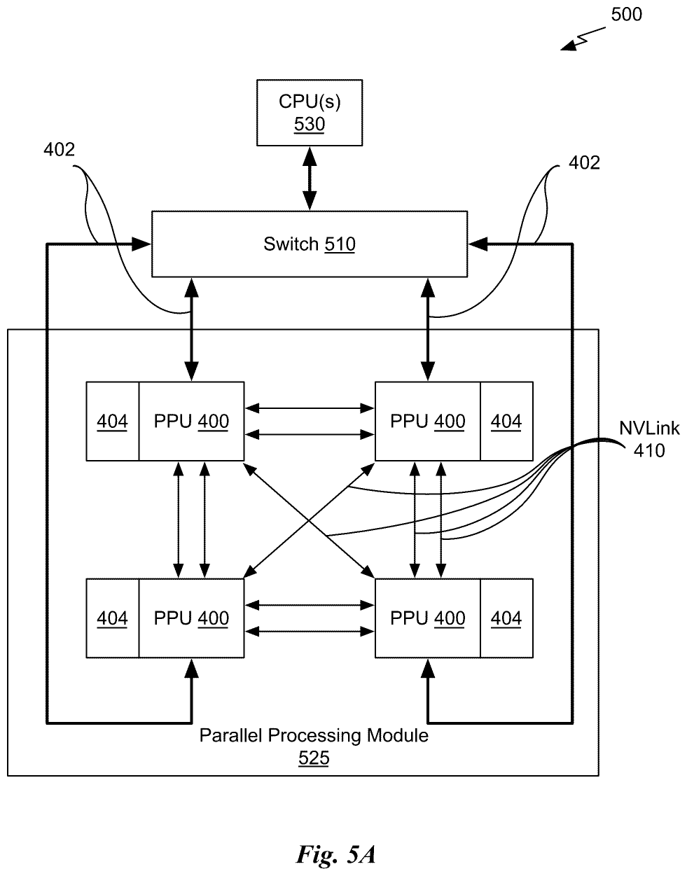

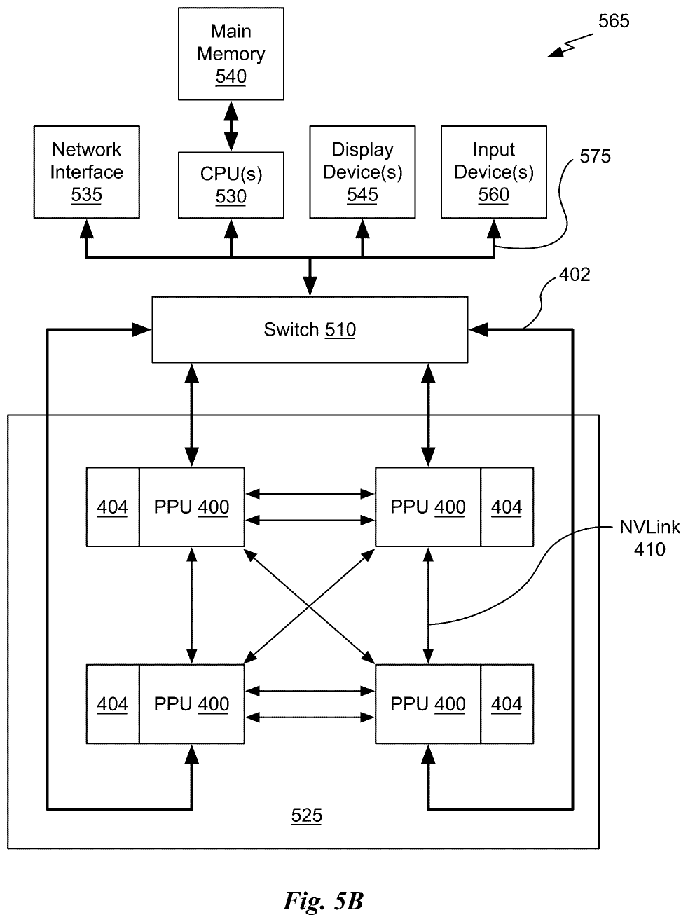

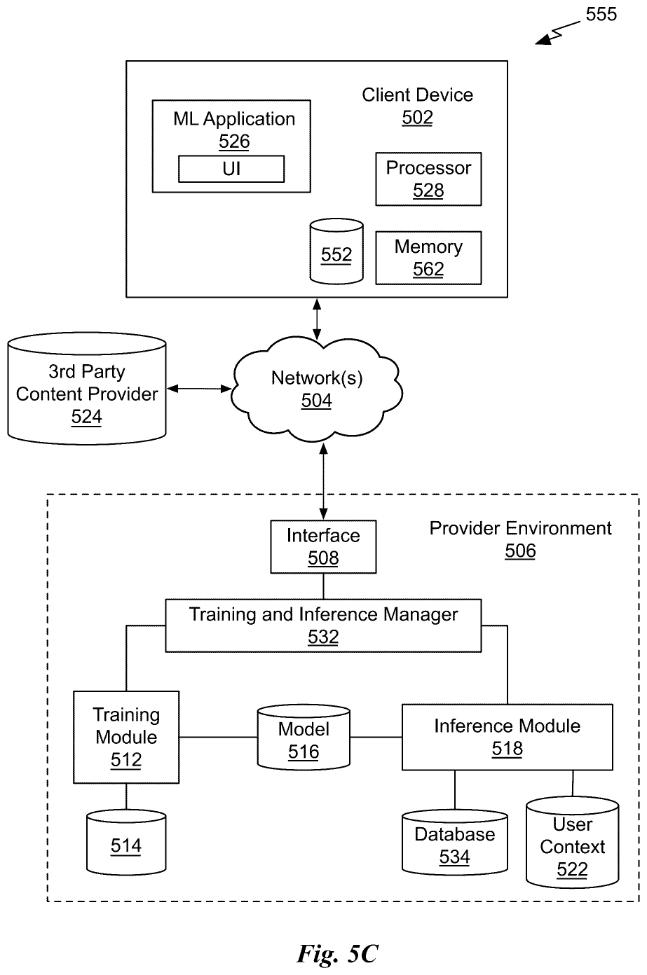

The NVLink 410 interconnect enables systems to scale and include one or more PPUs 400 combined with one or more CPUs, supports cache coherence between the PPUs 400 and CPUs, and CPU mastering. Data and/or commands may be transmitted by the NVLink 410 through the hub 430 to/from other units of the PPU 400 such as one or more copy engines, a video encoder, a video decoder, a power management unit, etc. (not explicitly shown). The NVLink 410 is described in more detail in conjunction with FIG. 5B.

The I/O unit 405 is configured to transmit and receive communications (e.g., commands, data, etc.) from a host processor (not shown) over the interconnect 402. The I/O unit 405 may communicate with the host processor directly via the interconnect 402 or through one or more intermediate devices such as a memory bridge. In an embodiment, the I/O unit 405 may communicate with one or more other processors, such as one or more the PPUs 400 via the interconnect 402. In an embodiment, the I/O unit 405 implements a Peripheral Component Interconnect Express (PCIe) interface for communications over a PCIe bus and the interconnect 402 is a PCIe bus. In alternative embodiments, the I/O unit 405 may implement other types of well-known interfaces for communicating with external devices.

The I/O unit 405 decodes packets received via the interconnect 402. In an embodiment, the packets represent commands configured to cause the PPU 400 to perform various operations. The I/O unit 405 transmits the decoded commands to various other units of the PPU 400 as the commands may specify. For example, some commands may be transmitted to the front end unit 415. Other commands may be transmitted to the hub 430 or other units of the PPU 400 such as one or more copy engines, a video encoder, a video decoder, a power management unit, etc. (not explicitly shown). In other words, the I/O unit 405 is configured to route communications between and among the various logical units of the PPU 400.

In an embodiment, a program executed by the host processor encodes a command stream in a buffer that provides workloads to the PPU 400 for processing. A workload may comprise several instructions and data to be processed by those instructions. The buffer is a region in a memory that is accessible (e.g., read/write) by both the host processor and the PPU 400. For example, the I/O unit 405 may be configured to access the buffer in a system memory connected to the interconnect 402 via memory requests transmitted over the interconnect 402. In an embodiment, the host processor writes the command stream to the buffer and then transmits a pointer to the start of the command stream to the PPU 400. The front end unit 415 receives pointers to one or more command streams. The front end unit 415 manages the one or more streams, reading commands from the streams and forwarding commands to the various units of the PPU 400.

The front end unit 415 is coupled to a scheduler unit 420 that configures the various GPCs 450 to process tasks defined by the one or more streams. The scheduler unit 420 is configured to track state information related to the various tasks managed by the scheduler unit 420. The state may indicate which GPC 450 a task is assigned to, whether the task is active or inactive, a priority level associated with the task, and so forth. The scheduler unit 420 manages the execution of a plurality of tasks on the one or more GPCs 450.

The scheduler unit 420 is coupled to a work distribution unit 425 that is configured to dispatch tasks for execution on the GPCs 450. The work distribution unit 425 may track a number of scheduled tasks received from the scheduler unit 420. In an embodiment, the work distribution unit 425 manages a pending task pool and an active task pool for each of the GPCs 450. As a GPC 450 finishes the execution of a task, that task is evicted from the active task pool for the GPC 450 and one of the other tasks from the pending task pool is selected and scheduled for execution on the GPC 450. If an active task has been idle on the GPC 450, such as while waiting for a data dependency to be resolved, then the active task may be evicted from the GPC 450 and returned to the pending task pool while another task in the pending task pool is selected and scheduled for execution on the GPC 450.

In an embodiment, a host processor executes a driver kernel that implements an application programming interface (API) that enables one or more applications executing on the host processor to schedule operations for execution on the PPU 400. In an embodiment, multiple compute applications are simultaneously executed by the PPU 400 and the PPU 400 provides isolation, quality of service (QoS), and independent address spaces for the multiple compute applications. An application may generate instructions (e.g., API calls) that cause the driver kernel to generate one or more tasks for execution by the PPU 400. The driver kernel outputs tasks to one or more streams being processed by the PPU 400. Each task may comprise one or more groups of related threads, referred to herein as a warp. In an embodiment, a warp comprises 32 related threads that may be executed in parallel. Cooperating threads may refer to a plurality of threads including instructions to perform the task and that may exchange data through shared memory. The tasks may be allocated to one or more processing units within a GPC 450 and instructions are scheduled for execution by at least one warp.

The work distribution unit 425 communicates with the one or more GPCs 450 via XBar 470. The XBar 470 is an interconnect network that couples many of the units of the PPU 400 to other units of the PPU 400. For example, the XBar 470 may be configured to couple the work distribution unit 425 to a particular GPC 450. Although not shown explicitly, one or more other units of the PPU 400 may also be connected to the XBar 470 via the hub 430.

The tasks are managed by the scheduler unit 420 and dispatched to a GPC 450 by the work distribution unit 425. The GPC 450 is configured to process the task and generate results. The results may be consumed by other tasks within the GPC 450, routed to a different GPC 450 via the XBar 470, or stored in the memory 404. The results can be written to the memory 404 via the memory partition units 480, which implement a memory interface for reading and writing data to/from the memory 404. The results can be transmitted to another PPU 400 or CPU via the NVLink 410. In an embodiment, the PPU 400 includes a number U of memory partition units 480 that is equal to the number of separate and distinct memory devices of the memory 404 coupled to the PPU 400. Each GPC 450 may include a memory management unit to provide translation of virtual addresses into physical addresses, memory protection, and arbitration of memory requests. In an embodiment, the memory management unit provides one or more translation lookaside buffers (TLBs) for performing translation of virtual addresses into physical addresses in the memory 404.

In an embodiment, the memory partition unit 480 includes a Raster Operations (ROP) unit, a level two (L2) cache, and a memory interface that is coupled to the memory 404. The memory interface may implement 32, 64, 128, 1024-bit data buses, or the like, for high-speed data transfer. The PPU 400 may be connected to up to Y memory devices, such as high bandwidth memory stacks or graphics double-data-rate, version 5, synchronous dynamic random access memory, or other types of persistent storage. In an embodiment, the memory interface implements an HBM2 memory interface and Y equals half U. In an embodiment, the HBM2 memory stacks are located on the same physical package as the PPU 400, providing substantial power and area savings compared with conventional GDDR5 SDRAM systems. In an embodiment, each HBM2 stack includes four memory dies and Y equals 4, with each HBM2 stack including two 128-bit channels per die for a total of 8 channels and a data bus width of 1024 bits.

In an embodiment, the memory 404 supports Single-Error Correcting Double-Error Detecting (SECDED)Error Correction Code (ECC) to protect data. ECC provides higher reliability for compute applications that are sensitive to data corruption. Reliability is especially important in large-scale cluster computing environments where PPUs 400 process very large datasets and/or run applications for extended periods.

In an embodiment, the PPU 400 implements a multi-level memory hierarchy. In an embodiment, the memory partition unit 480 supports a unified memory to provide a single unified virtual address space for CPU and PPU 400 memory, enabling data sharing between virtual memory systems. In an embodiment the frequency of accesses by a PPU 400 to memory located on other processors is traced to ensure that memory pages are moved to the physical memory of the PPU 400 that is accessing the pages more frequently. In an embodiment, the NVLink 410 supports address translation services allowing the PPU 400 to directly access a CPU's page tables and providing full access to CPU memory by the PPU 400.

In an embodiment, copy engines transfer data between multiple PPUs 400 or between PPUs 400 and CPUs. The copy engines can generate page faults for addresses that are not mapped into the page tables. The memory partition unit 480 can then service the page faults, mapping the addresses into the page table, after which the copy engine can perform the transfer. In a conventional system, memory is pinned (e.g., non-pageable) for multiple copy engine operations between multiple processors, substantially reducing the available memory. With hardware page faulting, addresses can be passed to the copy engines without worrying if the memory pages are resident, and the copy process is transparent.

Data from the memory 404 or other system memory may be fetched by the memory partition unit 480 and stored in the L2 cache 460, which is located on-chip and is shared between the various GPCs 450. As shown, each memory partition unit 480 includes a portion of the L2 cache associated with a corresponding memory 404. Lower level caches may then be implemented in various units within the GPCs 450. For example, each of the processing units within a GPC 450 may implement a level one (LI) cache. The L1 cache is private memory that is dedicated to a particular processing unit. The L2 cache 460 is coupled to the memory interface 470 and the XBar 470 and data from the L2 cache may be fetched and stored in each of the L1 caches for processing.

In an embodiment, the processing units within each GPC 450 implement a SIMD (Single-Instruction, Multiple-Data) architecture where each thread in a group of threads (e.g., a warp) is configured to process a different set of data based on the same set of instructions. All threads in the group of threads execute the same instructions. In another embodiment, the processing unit implements a SIMT (Single-Instruction, Multiple Thread) architecture where each thread in a group of threads is configured to process a different set of data based on the same set of instructions, but where individual threads in the group of threads are allowed to diverge during execution. In an embodiment, a program counter, call stack, and execution state is maintained for each warp, enabling concurrency between warps and serial execution within warps when threads within the warp diverge. In another embodiment, a program counter, call stack, and execution state is maintained for each individual thread, enabling equal concurrency between all threads, within and between warps. When execution state is maintained for each individual thread, threads executing the same instructions may be converged and executed in parallel for maximum efficiency.

Cooperative Groups is a programming model for organizing groups of communicating threads that allows developers to express the granularity at which threads are communicating, enabling the expression of richer, more efficient parallel decompositions. Cooperative launch APIs support synchronization amongst thread blocks for the execution of parallel algorithms. Conventional programming models provide a single, simple construct for synchronizing cooperating threads: a barrier across all threads of a thread block (e.g., the syncthreads( ) function). However, programmers would often like to define groups of threads at smaller than thread block granularities and synchronize within the defined groups to enable greater performance, design flexibility, and software reuse in the form of collective group-wide function interfaces.

Cooperative Groups enables programmers to define groups of threads explicitly at sub-block (e.g., as small as a single thread) and multi-block granularities, and to perform collective operations such as synchronization on the threads in a cooperative group. The programming model supports clean composition across software boundaries, so that libraries and utility functions can synchronize safely within their local context without having to make assumptions about convergence. Cooperative Groups primitives enable new patterns of cooperative parallelism, including producer-consumer parallelism, opportunistic parallelism, and global synchronization across an entire grid of thread blocks.

Each processing unit includes a large number (e.g., 128, etc.) of distinct processing cores (e.g., functional units) that may be fully-pipelined, single-precision, double-precision, and/or mixed precision and include a floating point arithmetic logic unit and an integer arithmetic logic unit. In an embodiment, the floating point arithmetic logic units implement the IEEE 754-2008 standard for floating point arithmetic. In an embodiment, the cores include 64 single-precision (32-bit) floating point cores, 64 integer cores, 32 double-precision (64-bit) floating point cores, and 8 tensor cores.

Tensor cores configured to perform matrix operations. In particular, the tensor cores are configured to perform deep learning matrix arithmetic, such as GEMM (matrix-matrix multiplication) for convolution operations during neural network training and inferencing. In an embodiment, each tensor core operates on a 4×4 matrix and performs a matrix multiply and accumulate operation D=A×B+C, where A, B, C, and D are 4×4 matrices.

In an embodiment, the matrix multiply inputs A and B may be integer, fixed-point, or floating point matrices, while the accumulation matrices C and D may be integer, fixed-point, or floating point matrices of equal or higher bitwidths. In an embodiment, tensor cores operate on one, four, or eight bit integer input data with 32-bit integer accumulation. The 8-bit integer matrix multiply requires 1024 operations and results in a full precision product that is then accumulated using 32-bit integer addition with the other intermediate products for a 8×8×16 matrix multiply. In an embodiment, tensor Cores operate on 16-bit floating point input data with 32-bit floating point accumulation. The 16-bit floating point multiply requires 64 operations and results in a full precision product that is then accumulated using 32-bit floating point addition with the other intermediate products for a 4×4×4 matrix multiply. In practice, Tensor Cores are used to perform much larger two-dimensional or higher dimensional matrix operations, built up from these smaller elements. An API, such as CUDA 9 C++ API, exposes specialized matrix load, matrix multiply and accumulate, and matrix store operations to efficiently use Tensor Cores from a CUDA-C++ program. At the CUDA level, the warp-level interface assumes 16×16 size matrices spanning all 32 threads of the warp.

Each processing unit may also comprise M special function units (SFUs) that perform special functions (e.g., attribute evaluation, reciprocal square root, and the like). In an embodiment, the SFUs may include a tree traversal unit configured to traverse a hierarchical tree data structure. In an embodiment, the SFUs may include texture unit configured to perform texture map filtering operations. In an embodiment, the texture units are configured to load texture maps (e.g., a 2D array of texels) from the memory 404 and sample the texture maps to produce sampled texture values for use in shader programs executed by the processing unit. In an embodiment, the texture maps are stored in shared memory that may comprise or include an L1 cache. The texture units implement texture operations such as filtering operations using mip-maps (e.g., texture maps of varying levels of detail). In an embodiment, each processing unit includes two texture units.

Each processing unit also comprises N load store units (LSUs) that implement load and store operations between the shared memory and the register file. Each processing unit includes an interconnect network that connects each of the cores to the register file and the LSU to the register file, shared memory. In an embodiment, the interconnect network is a crossbar that can be configured to connect any of the cores to any of the registers in the register file and connect the LSUs to the register file and memory locations in shared memory.

The shared memory is an array of on-chip memory that allows for data storage and communication between the processing units and between threads within a processing unit. In an embodiment, the shared memory comprises 128 KB of storage capacity and is in the path from each of the processing units to the memory partition unit 480. The shared memory can be used to cache reads and writes. One or more of the shared memory, L1 cache, L2 cache, and memory 404 are backing stores.

Combining data cache and shared memory functionality into a single memory block provides the best overall performance for both types of memory accesses. The capacity is usable as a cache by programs that do not use shared memory. For example, if shared memory is configured to use half of the capacity, texture and load/store operations can use the remaining capacity. Integration within the shared memory enables the shared memory to function as a high-throughput conduit for streaming data while simultaneously providing high-bandwidth and low-latency access to frequently reused data.

When configured for general purpose parallel computation, a simpler configuration can be used compared with graphics processing. Specifically, fixed function graphics processing units, are bypassed, creating a much simpler programming model. In the general purpose parallel computation configuration, the work distribution unit 425 assigns and distributes blocks of threads directly to the processing units within the GPCs 450. Threads execute the same program, using a unique thread ID in the calculation to ensure each thread generates unique results, using the processing unit(s) to execute the program and perform calculations, shared memory to communicate between threads, and the LSU to read and write global memory through the shared memory and the memory partition unit 480. When configured for general purpose parallel computation, the processing units can also write commands that the scheduler unit 420 can use to launch new work on the processing units.

The PPUs 400 may each include, and/or be configured to perform functions of, one or more processing cores and/or components thereof, such as Tensor Cores (TCs), Tensor Processing Units(TPUs), Pixel Visual Cores (PVCs), Ray Tracing (RT) Cores, Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The PPU 400 may be included in a desktop computer, a laptop computer, a tablet computer, servers, supercomputers, a smart-phone (e.g., a wireless, hand-held device), personal digital assistant (PDA), a digital camera, a vehicle, a head mounted display, a hand-held electronic device, and the like. In an embodiment, the PPU 400 is embodied on a single semiconductor substrate. In another embodiment, the PPU 400 is included in a system-on-a-chip (SoC) along with one or more other devices such as additional PPUs 400, the memory 404, a reduced instruction set computer (RISC) CPU, a memory management unit (MMU), a digital-to-analog converter (DAC), and the like.

In an embodiment, the PPU 400 may be included on a graphics card that includes one or more memory devices. The graphics card may be configured to interface with a PCIe slot on a motherboard of a desktop computer. In yet another embodiment, the PPU 400 may be an integrated graphics processing unit (iGPU) or parallel processor included in the chipset of the motherboard. In yet another embodiment, the PPU 400 may be realized in reconfigurable hardware. In yet another embodiment, parts of the PPU 400 may be realized in reconfigurable hardware.

### Exemplary Computing System

Systems with multiple GPUs and CPUs are used in a variety of industries as developers expose and leverage more parallelism in applications such as artificial intelligence computing. High-performance GPU-accelerated systems with tens to many thousands of compute nodes are deployed in data centers, research facilities, and supercomputers to solve ever larger problems. As the number of processing devices within the high-performance systems increases, the communication and data transfer mechanisms need to scale to support the increased bandwidth.

FIG. 5A is a conceptual diagram of a processing system 500 implemented using the PPU 400 of FIG. 4, in accordance with an embodiment. The processing system 500 includes a CPU 530, switch 510, and multiple PPUs 400, and respective memories 404.

The NVLink 410 provides high-speed communication links between each of the PPUs 400. Although a particular number of NVLink 410 and interconnect 402 connections are illustrated in FIG. 5B, the number of connections to each PPU 400 and the CPU 530 may vary. The switch 510 interfaces between the interconnect 402 and the CPU 530. The PPUs 400, memories 404, and NVLinks 410 may be situated on a single semiconductor platform to form a parallel processing module 525. In an embodiment, the switch 510 supports two or more protocols to interface between various different connections and/or links.

In another embodiment (not shown), the NVLink 410 provides one or more high-speed communication links between each of the PPUs 400 and the CPU 530 and the switch 510 interfaces between the interconnect 402 and each of the PPUs 400. The PPUs 400, memories 404, and interconnect 402 may be situated on a single semiconductor platform to form a parallel processing module 525. In yet another embodiment (not shown), the interconnect 402 provides one or more communication links between each of the PPUs 400 and the CPU 530 and the switch 510 interfaces between each of the PPUs 400 using the NVLink 410 to provide one or more high-speed communication links between the PPUs 400. In another embodiment (not shown), the NVLink 410 provides one or more high-speed communication links between the PPUs 400 and the CPU 530 through the switch 510. In yet another embodiment (not shown), the interconnect 402 provides one or more communication links between each of the PPUs 400 directly. One or more of the NVLink 410 high-speed communication links may be implemented as a physical NVLink interconnect or either an on-chip or on-die interconnect using the same protocol as the NVLink 410.

In the context of the present description, a single semiconductor platform may refer to a sole unitary semiconductor-based integrated circuit fabricated on a die or chip. It should be noted that the term single semiconductor platform may also refer to multi-chip modules with increased connectivity which simulate on-chip operation and make substantial improvements over utilizing a conventional bus implementation. Of course, the various circuits or devices may also be situated separately or in various combinations of semiconductor platforms per the desires of the user. Alternately, the parallel processing module 525 may be implemented as a circuit board substrate and each of the PPUs 400 and/or memories 404 may be packaged devices. In an embodiment, the CPU 530, switch 510, and the parallel processing module 525 are situated on a single semiconductor platform.

In an embodiment, the signaling rate of each NVLink 410 is 20 to 25 Gigabits/second and each PPU 400 includes six NVLink 410 interfaces (as shown in FIG. 5A, five NVLink 410 interfaces are included for each PPU 400). Each NVLink 410 provides a data transfer rate of 25 Gigabytes/second in each direction, with six links providing 400 Gigabytes/second. The NVLinks 410 can be used exclusively for PPU-to-PPU communication as shown in FIG. 5A, or some combination of PPU-to-PPU and PPU-to-CPU, when the CPU 530 also includes one or more NVLink 410 interfaces.

In an embodiment, the NVLink 410 allows direct load/store/atomic access from the CPU 530 to each PPU's 400 memory 404. In an embodiment, the NVLink 410 supports coherency operations, allowing data read from the memories 404 to be stored in the cache hierarchy of the CPU 530, reducing cache access latency for the CPU 530. In an embodiment, the NVLink 410 includes support for Address Translation Services (ATS), allowing the PPU 400 to directly access page tables within the CPU 530. One or more of the NVLinks 410 may also be configured to operate in a low-power mode.

FIG. 5B illustrates an exemplary system 565 in which the various architecture and/or functionality of the various previous embodiments may be implemented.

As shown, a system 565 is provided including at least one central processing unit 530 that is connected to a communication bus 575. The communication bus 575 may directly or indirectly couple one or more of the following devices: main memory 540, network interface 535, CPU(s) 530, display device(s) 545, input device(s) 560, switch 510, and parallel processing system 525. The communication bus 575 may be implemented using any suitable protocol and may represent one or more links or busses, such as an address bus, a data bus, a control bus, or a combination thereof. The communication bus 575 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, HyperTransport, and/or another type of bus or link. In some embodiments, there are direct connections between components. As an example, the CPU(s) 530 may be directly connected to the main memory 540. Further, the CPU(s) 530 may be directly connected to the parallel processing system 525. Where there is direct, or point-to-point connection between components, the communication bus 575 may include a PCIe link to carry out the connection. In these examples, a PCI bus need not be included in the system 565.

Although the various blocks of FIG. 5C are shown as connected via the communication bus 575 with lines, this is not intended to be limiting and is for clarity only. For example, in some embodiments, a presentation component, such as display device(s) 545, may be considered an I/O component, such as input device(s) 560 (e.g., if the display is a touch screen). As another example, the CPU(s) 530 and/or parallel processing system 525 may include memory (e.g., the main memory 540 may be representative of a storage device in addition to the parallel processing system 525, the CPUs 530, and/or other components). In other words, the computing device of FIG. 5C is merely illustrative. Distinction is not made between such categories as “workstation,” “server,” “laptop,” “desktop,” “tablet,” “cclient device,” “mobile device,” “hand-held device,” “game console,” “electronic control unit (ECU),” “virtual reality system,” and/or other device or system types, as all are contemplated within the scope of the computing device of FIG. 5C.

The system 565 also includes a main memory 540. Control logic (software) and data are stored in the main memory 540 which may take the form of a variety of computer-readable media. The computer-readable media may be any available media that may be accessed by the system 565. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the main memory 540 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by system 565. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

Computer programs, when executed, enable the system 565 to perform various functions. The CPU(s) 530 may be configured to execute at least some of the computer-readable instructions to control one or more components of the system 565 to perform one or more of the methods and/or processes described herein. The CPU(s) 530 may each include one or more cores (e.g., one, two, four, eight, twenty-eight, seventy-two, etc.) that are capable of handling a multitude of software threads simultaneously. The CPU(s) 530 may include any type of processor, and may include different types of processors depending on the type of system 565 implemented (e.g., processors with fewer cores for mobile devices and processors with more cores for servers). For example, depending on the type of system 565, the processor may be an Advanced RISC Machines (ARM) processor implemented using Reduced Instruction Set Computing (RISC) or an x86 processor implemented using Complex Instruction Set Computing (CISC). The system 565 may include one or more CPUs 530 in addition to one or more microprocessors or supplementary co-processors, such as math co-processors.

In addition to or alternatively from the CPU(s) 530, the parallel processing module 525 may be configured to execute at least some of the computer-readable instructions to control one or more components of the system 565 to perform one or more of the methods and/or processes described herein. The parallel processing module 525 may be used by the system 565 to render graphics (e.g., 3D graphics) or perform general purpose computations. For example, the parallel processing module 525 may be used for General-Purpose computing on GPUs (GPGPU). In embodiments, the CPU(s) 530 and/or the parallel processing module 525 may discretely or jointly perform any combination of the methods, processes and/or portions thereof.

The system 565 also includes input device(s) 560, the parallel processing system 525, and display device(s) 545. The display device(s) 545 may include a display (e.g., a monitor, a touch screen, a television screen, a heads-up-display (HUD), other display types, or a combination thereof), speakers, and/or other presentation components. The display device(s) 545 may receive data from other components (e.g., the parallel processing system 525, the CPU(s) 530, etc.), and output the data (e.g., as an image, video, sound, etc.).

The network interface 535 may enable the system 565 to be logically coupled to other devices including the input devices 560, the display device(s) 545, and/or other components, some of which may be built in to (e.g., integrated in) the system 565. Illustrative input devices 560 include a microphone, mouse, keyboard, joystick, game pad, game controller, satellite dish, scanner, printer, wireless device, etc. The input devices 560 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the system 565. The system 565 may be include depth cameras, such as stereoscopic camera systems, infrared camera systems, RGB camera systems, touchscreen technology, and combinations of these, for gesture detection and recognition. Additionally, the system 565 may include accelerometers or gyroscopes (e.g., as part of an inertia measurement unit (IMU)) that enable detection of motion. In some examples, the output of the accelerometers or gyroscopes may be used by the system 565 to render immersive augmented reality or virtual reality.

Further, the system 565 may be coupled to a network (e.g., a telecommunications network, local area network (LAN), wireless network, wide area network (WAN) such as the Internet, peer-to-peer network, cable network, or the like) through a network interface 535 for communication purposes. The system 565 may be included within a distributed network and/or cloud computing environment.

The network interface 535 may include one or more receivers, transmitters, and/or transceivers that enable the system 565 to communicate with other computing devices via an electronic communication network, included wired and/or wireless communications. The network interface 535 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet.

The system 565 may also include a secondary storage (not shown). The secondary storage 610 includes, for example, a hard disk drive and/or a removable storage drive, representing a floppy disk drive, a magnetic tape drive, a compact disk drive, digital versatile disk (DVD) drive, recording device, universal serial bus (USB) flash memory. The removable storage drive reads from and/or writes to a removable storage unit in a well-known manner. The system 565 may also include a hard-wired power supply, a battery power supply, or a combination thereof (not shown). The power supply may provide power to the system 565 to enable the components of the system 565 to operate.

Each of the foregoing modules and/or devices may even be situated on a single semiconductor platform to form the system 565. Alternately, the various modules may also be situated separately or in various combinations of semiconductor platforms per the desires of the user. While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the processing system 500 of FIG. 5A and/or exemplary system 565 of FIG. 5B—e.g., each device may include similar components, features, and/or functionality of the processing system 500 and/or exemplary system 565.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example processing system 500 of FIG. 5B and/or exemplary system 565 of FIG. 5C. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

### Machine Learning

Deep neural networks (DNNs) developed on processors, such as the PPU 400 have been used for diverse use cases, from self-driving cars to faster drug development, from automatic image captioning in online image databases to smart real-time language translation in video chat applications. Deep learning is a technique that models the neural learning process of the human brain, continually learning, continually getting smarter, and delivering more accurate results more quickly over time. A child is initially taught by an adult to correctly identify and classify various shapes, eventually being able to identify shapes without any coaching. Similarly, a deep learning or neural learning system needs to be trained in object recognition and classification for it get smarter and more efficient at identifying basic objects, occluded objects, etc., while also assigning context to objects.

At the simplest level, neurons in the human brain look at various inputs that are received, importance levels are assigned to each of these inputs, and output is passed on to other neurons to act upon. An artificial neuron or perceptron is the most basic model of a neural network. In one example, a perceptron may receive one or more inputs that represent various features of an object that the perceptron is being trained to recognize and classify, and each of these features is assigned a certain weight based on the importance of that feature in defining the shape of an object.

A deep neural network (DNN) model includes multiple layers of many connected nodes (e.g., perceptrons, Boltzmann machines, radial basis functions, convolutional layers, etc.) that can be trained with enormous amounts of input data to quickly solve complex problems with high accuracy. In one example, a first layer of the DNN model breaks down an input image of an automobile into various sections and looks for basic patterns such as lines and angles. The second layer assembles the lines to look for higher level patterns such as wheels, windshields, and mirrors. The next layer identifies the type of vehicle, and the final few layers generate a label for the input image, identifying the model of a specific automobile brand.

Once the DNN is trained, the DNN can be deployed and used to identify and classify objects or patterns in a process known as inference. Examples of inference (the process through which a DNN extracts useful information from a given input) include identifying handwritten numbers on checks deposited into ATM machines, identifying images of friends in photos, delivering movie recommendations to over fifty million users, identifying and classifying different types of automobiles, pedestrians, and road hazards in driverless cars, or translating human speech in real-time.

During training, data flows through the DNN in a forward propagation phase until a prediction is produced that indicates a label corresponding to the input. If the neural network does not correctly label the input, then errors between the correct label and the predicted label are analyzed, and the weights are adjusted for each feature during a backward propagation phase until the DNN correctly labels the input and other inputs in a training dataset. Training complex neural networks requires massive amounts of parallel computing performance, including floating-point multiplications and additions that are supported by the PPU 400. Inferencing is less compute-intensive than training, being a latency-sensitive process where a trained neural network is applied to new inputs it has not seen before to classify images, detect emotions, identify recommendations, recognize and translate speech, and generally infer new information.

Neural networks rely heavily on matrix math operations, and complex multi-layered networks require tremendous amounts of floating-point performance and bandwidth for both efficiency and speed. With thousands of processing cores, optimized for matrix math operations, and delivering tens to hundreds of TFLOPS of performance, the PPU 400 is a computing platform capable of delivering performance required for deep neural network-based artificial intelligence and machine learning applications.

Furthermore, images generated applying one or more of the techniques disclosed herein may be used to train, test, or certify DNNs used to recognize objects and environments in the real world. Such images may include scenes of roadways, factories, buildings, urban settings, rural settings, humans, animals, and any other physical object or real-world setting. Such images may be used to train, test, or certify DNNs that are employed in machines or robots to manipulate, handle, or modify physical objects in the real world. Furthermore, such images may be used to train, test, or certify DNNs that are employed in autonomous vehicles to navigate and move the vehicles through the real world. Additionally, images generated applying one or more of the techniques disclosed herein may be used to convey information to users of such machines, robots, and vehicles.

FIG. 5C illustrates components of an exemplary system 555 that can be used to train and utilize machine learning, in accordance with at least one embodiment. As will be discussed, various components can be provided by various combinations of computing devices and resources, or a single computing system, which may be under control of a single entity or multiple entities. Further, aspects may be triggered, initiated, or requested by different entities. In at least one embodiment training of a neural network might be instructed by a provider associated with provider environment 506, while in at least one embodiment training might be requested by a customer or other user having access to a provider environment through a client device 502 or other such resource. In at least one embodiment, training data (or data to be analyzed by a trained neural network) can be provided by a provider, a user, or a third party content provider 524. In at least one embodiment, client device 502 may be a vehicle or object that is to be navigated on behalf of a user, for example, which can submit requests and/or receive instructions that assist in navigation of a device.

In at least one embodiment, requests are able to be submitted across at least one network 504 to be received by a provider environment 506. In at least one embodiment, a client device may be any appropriate electronic and/or computing devices enabling a user to generate and send such requests, such as, but not limited to, desktop computers, notebook computers, computer servers, smartphones, tablet computers, gaming consoles (portable or otherwise), computer processors, computing logic, and set-top boxes. Network(s) 504 can include any appropriate network for transmitting a request or other such data, as may include Internet, an intranet, an Ethernet, a cellular network, a local area network (LAN), a wide area network (WAN), a personal area network (PAN), an ad hoc network of direct wireless connections among peers, and so on.

In at least one embodiment, requests can be received at an interface layer 508, which can forward data to a training and inference manager 532, in this example. The training and inference manager 532 can be a system or service including hardware and software for managing requests and service corresponding data or content, in at least one embodiment, the training and inference manager 532 can receive a request to train a neural network, and can provide data for a request to a training module 512. In at least one embodiment, training module 512 can select an appropriate model or neural network to be used, if not specified by the request, and can train a model using relevant training data. In at least one embodiment, training data can be a batch of data stored in a training data repository 514, received from client device 502, or obtained from a third party provider 524. In at least one embodiment, training module 512 can be responsible for training data. A neural network can be any appropriate network, such as a recurrent neural network (RNN) or convolutional neural network (CNN). Once a neural network is trained and successfully evaluated, a trained neural network can be stored in a model repository 516, for example, that may store different models or networks for users, applications, or services, etc. In at least one embodiment, there may be multiple models for a single application or entity, as may be utilized based on a number of different factors.

In at least one embodiment, at a subsequent point in time, a request may be received from client device 502 (or another such device) for content (e.g., path determinations) or data that is at least partially determined or impacted by a trained neural network. This request can include, for example, input data to be processed using a neural network to obtain one or more inferences or other output values, classifications, or predictions, or for at least one embodiment, input data can be received by interface layer 508 and directed to inference module 518, although a different system or service can be used as well. In at least one embodiment, inference module 518 can obtain an appropriate trained network, such as a trained deep neural network (DNN) as discussed herein, from model repository 516 if not already stored locally to inference module 518. Inference module 518 can provide data as input to a trained network, which can then generate one or more inferences as output. This may include, for example, a classification of an instance of input data. In at least one embodiment, inferences can then be transmitted to client device 502 for display or other communication to a user. In at least one embodiment, context data for a user may also be stored to a user context data repository 522, which may include data about a user which may be useful as input to a network in generating inferences, or determining data to return to a user after obtaining instances. In at least one embodiment, relevant data, which may include at least some of input or inference data, may also be stored to a local database 534 for processing future requests. In at least one embodiment, a user can use account information or other information to access resources or functionality of a provider environment. In at least one embodiment, if permitted and available, user data may also be collected and used to further train models, in order to provide more accurate inferences for future requests. In at least one embodiment, requests may be received through a user interface to a machine learning application 526 executing on client device 502, and results displayed through a same interface. A client device can include resources such as a processor 528 and memory 562 for generating a request and processing results or a response, as well as at least one data storage element 552 for storing data for machine learning application 526.

In at least one embodiment a processor 528 (or a processor of training module 512 or inference module 518) will be a central processing unit (CPU). As mentioned, however, resources in such environments can utilize GPUs to process data for at least certain types of requests. With thousands of cores, GPUs, such as PPU 300 are designed to handle substantial parallel workloads and, therefore, have become popular in deep learning for training neural networks and generating predictions. While use of GPUs for offline builds has enabled faster training of larger and more complex models, generating predictions offline implies that either request-time input features cannot be used or predictions must be generated for all permutations of features and stored in a lookup table to serve real-time requests. If a deep learning framework supports a CPU-mode and a model is small and simple enough to perform a feed-forward on a CPU with a reasonable latency, then a service on a CPU instance could host a model. In this case, training can be done offline on a GPU and inference done in real-time on a CPU. If a CPU approach is not viable, then a service can run on a GPU instance. Because GPUs have different performance and cost characteristics than CPUs, however, running a service that offloads a runtime algorithm to a GPU can require it to be designed differently from a CPU based service.

In at least one embodiment, video data can be provided from client device 502 for enhancement in provider environment 506. In at least one embodiment, video data can be processed for enhancement on client device 502. In at least one embodiment, video data may be streamed from a third party content provider 524 and enhanced by third party content provider 524, provider environment 506, or client device 502. In at least one embodiment, video data can be provided from client device 502 for use as training data in provider environment 506.

In at least one embodiment, supervised and/or unsupervised training can be performed by the client device 502 and/or the provider environment 506. In at least one embodiment, a set of training data 514 (e.g., classified or labeled data) is provided as input to function as training data. In an embodiment, the set of training data may be used in a generative adversarial training configuration to train a generator neural network.

In at least one embodiment, training data can include images of at least one human subject, avatar, or character for which a neural network is to be trained. In at least one embodiment, training data can include instances of at least one type of object for which a neural network is to be trained, as well as information that identifies that type of object. In at least one embodiment, training data might include a set of images that each includes a representation of a type of object, where each image also includes, or is associated with, a label, metadata, classification, or other piece of information identifying a type of object represented in a respective image. Various other types of data may be used as training data as well, as may include text data, audio data, video data, and so on. In at least one embodiment, training data 514 is provided as training input to a training module 512. In at least one embodiment, training module 512 can be a system or service that includes hardware and software, such as one or more computing devices executing a training application, for training a neural network (or other model or algorithm, etc.). In at least one embodiment, training module 512 receives an instruction or request indicating a type of model to be used for training, in at least one embodiment, a model can be any appropriate statistical model, network, or algorithm useful for such purposes, as may include an artificial neural network, deep learning algorithm, learning classifier, Bayesian network, and so on. In at least one embodiment, training module 512 can select an initial model, or other untrained model, from an appropriate repository 516 and utilize training data 514 to train a model, thereby generating a trained model (e.g., trained deep neural network) that can be used to classify similar types of data, or generate other such inferences. In at least one embodiment where training data is not used, an appropriate initial model can still be selected for training on input data per training module 512.

In at least one embodiment, a model can be trained in a number of different ways, as may depend in part upon a type of model selected. In at least one embodiment, a machine learning algorithm can be provided with a set of training data, where a model is a model artifact created by a training process. In at least one embodiment, each instance of training data contains a correct answer (e.g., classification), which can be referred to as a target or target attribute. In at least one embodiment, a learning algorithm finds patterns in training data that map input data attributes to a target, an answer to be predicted, and a machine learning model is output that captures these patterns. In at least one embodiment, a machine learning model can then be used to obtain predictions on new data for which a target is not specified.

In at least one embodiment, training and inference manager 532 can select from a set of machine learning models including binary classification, multiclass classification, generative, and regression models. In at least one embodiment, a type of model to be used can depend at least in part upon a type of target to be predicted.

### Example Streaming System

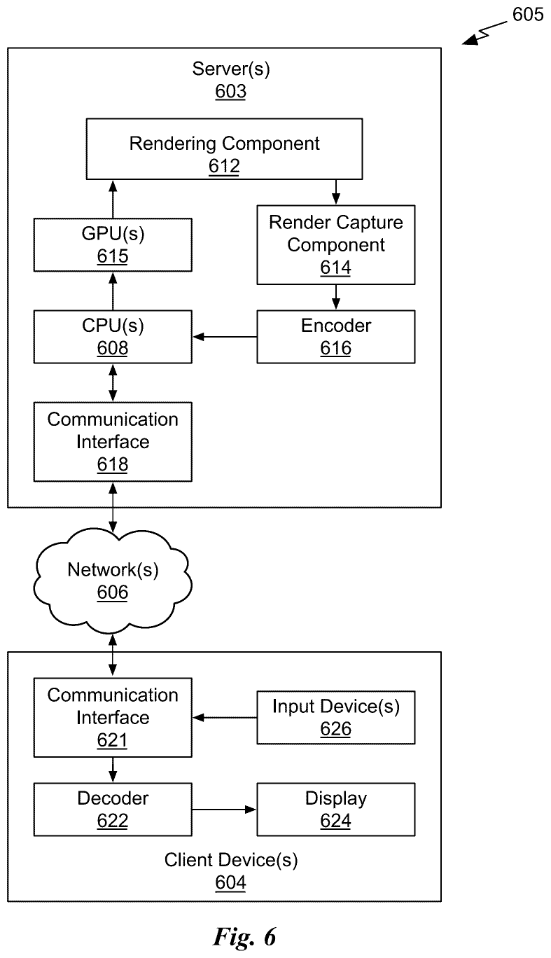

FIG. 6 is an example system diagram for a streaming system 605, in accordance with some embodiments of the present disclosure. In an embodiment, the streaming system 605 is a game streaming system. FIG. 6 includes server(s) 603 (which may include similar components, features, and/or functionality to the example processing system 500 of FIG. 5A and/or exemplary system 565 of FIG. 5B), client device(s) 604 (which may include similar components, features, and/or functionality to the example processing system 500 of FIG. 5A and/or exemplary system 565 of FIG. 5B), and network(s) 606 (which may be similar to the network(s) described herein). In some embodiments of the present disclosure, the system 605 may be implemented.

In the system 605, for a session (e.g., gaming session), the client device(s) 604 may only receive input data in response to inputs to the input device(s), transmit the input data to the server(s) 603, receive encoded display data from the server(s) 603, and display the display data on the display 624. As such, the more computationally intense computing and processing is offloaded to the server(s) 603 (e.g., rendering—in particular ray or path tracing—for graphical output of the session is executed by the GPU(s) of the server(s) 603). In other words, the session is streamed to the client device(s) 604 from the server(s) 603, thereby reducing the requirements of the client device(s) 604 for graphics processing and rendering.

For example, with respect to an instantiation of a session, a client device 604 may be displaying a frame of the session on the display 624 based on receiving the display data from the server(s) 603. The client device 604 may receive an input to one of the input device(s) and generate input data in response. The client device 604 may transmit the input data to the server(s) 603 via the communication interface 621 and over the network(s) 606 (e.g., the Internet), and the server(s) 603 may receive the input data via the communication interface 618. The CPU(s) may receive the input data, process the input data, and transmit data to the GPU(s) that causes the GPU(s) to generate a rendering of the session. For example, the input data may be representative of a movement of a character of the user in a game, firing a weapon, reloading, passing a ball, turning a vehicle, etc. The rendering component 612 may render the session (e.g., representative of the result of the input data) and the render capture component 614 may capture the rendering of the session as display data (e.g., as image data capturing the rendered frame of the session). The rendering of the session may include ray or path-traced lighting and/or shadow effects, computed using one or more parallel processing units—such as GPUs, which may further employ the use of one or more dedicated hardware accelerators or processing cores to perform ray or path-tracing techniques—of the server(s) 603. The encoder 616 may then encode the display data to generate encoded display data and the encoded display data may be transmitted to the client device 604 over the network(s) 606 via the communication interface 618. The client device 604 may receive the encoded display data via the communication interface 621 and the decoder 622 may decode the encoded display data to generate the display data. The client device 604 may then display the display data via the display 624.

It is noted that the techniques described herein may be embodied in executable instructions stored in a computer readable medium for use by or in connection with a processor-based instruction execution machine, system, apparatus, or device. It will be appreciated by those skilled in the art that, for some embodiments, various types of computer-readable media can be included for storing data. As used herein, a “computer-readable medium” includes one or more of any suitable media for storing the executable instructions of a computer program such that the instruction execution machine, system, apparatus, or device may read (or fetch) the instructions from the computer-readable medium and execute the instructions for carrying out the described embodiments. Suitable storage formats include one or more of an electronic, magnetic, optical, and electromagnetic format. A non-exhaustive list of conventional exemplary computer-readable medium includes: a portable computer diskette; a random-access memory (RAM); a read-only memory (ROM); an erasable programmable read only memory (EPROM); a flash memory device; and optical storage devices, including a portable compact disc (CD), a portable digital video disc (DVD), and the like.

It should be understood that the arrangement of components illustrated in the attached Figures are for illustrative purposes and that other arrangements are possible. For example, one or more of the elements described herein may be realized, in whole or in part, as an electronic hardware component. Other elements may be implemented in software, hardware, or a combination of software and hardware. Moreover, some or all of these other elements may be combined, some may be omitted altogether, and additional components may be added while still achieving the functionality described herein. Thus, the subject matter described herein may be embodied in many different variations, and all such variations are contemplated to be within the scope of the claims.

To facilitate an understanding of the subject matter described herein, many aspects are described in terms of sequences of actions. It will be recognized by those skilled in the art that the various actions may be performed by specialized circuits or circuitry, by program instructions being executed by one or more processors, or by a combination of both. The description herein of any sequence of actions is not intended to imply that the specific order described for performing that sequence must be followed. All methods described herein may be performed in any suitable order unless otherwise indicated herein or otherwise clearly contradicted by context.

The use of the terms “a” and “an” and “the” and similar references in the context of describing the subject matter (particularly in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. Furthermore, the foregoing description is for the purpose of illustration only, and not for the purpose of limitation, as the scope of protection sought is defined by the claims as set forth hereinafter together with any equivalents thereof. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

What is claimed is:

1. A computer-implemented method for using a blob-grounded text-to-image diffusion model to generate images, comprising:
obtaining a blob representation for an object to be generated within an output image, wherein the blob representation comprises a blob parameter and blob description, wherein the blob parameter indicates a plurality of variables that define an ellipse for the object and the blob description indicates a textual description of the object; and
inputting the blob representation into the blob-grounded text-to-image diffusion model to generate the output image.

2. The computer-implemented method of claim 1, further comprising:
training the blob-grounded text-to-image diffusion model using training data comprising a training image and one or more training models.

3. The computer-implemented method of claim 2, wherein training the blob-grounded text-to-image diffusion model comprises:
inputting the training image into an open vocabulary segmentation model to generate one or more training blob parameters;
inputting the one or more training blob parameters and the training image into a vision language model to generate one or more training blob descriptions;
inputting the one or more training blob parameters and the one or more training blob descriptions into the blob-grounded text-to-image diffusion model to generate a training output image; and
training the blob-grounded text-to-image diffusion model based on comparing the training output image with the training image.

4. The computer-implemented method of claim 3, wherein the open vocabulary segmentation model is an open-vocabulary diffusion-based panoptic segmentation (ODISE) model, and wherein inputting the training image into the open vocabulary segmentation model to generate the one or more training blob parameters comprises:
inputting an embedding of the input image into the ODISE model to generate instance segmentation maps; and
using an ellipse fitting optimization algorithm to generate the one or more training blob parameters from the instance segmentation maps.

5. The computer-implemented method of claim 3, wherein the vision language model is a Large Language and Vision Assistance (LLaVA) model, and wherein each of the one or more training blob descriptions comprises captions that describe a training blob parameter from the one or more training blob parameters.

6. The computer-implemented method of claim 1, wherein the blob-grounded text-to-image diffusion model is a modified stable diffusion model that comprises an encoder, a decoder, and a blob-grounded U-Net architecture, wherein the blob-grounded U-Net architecture comprises blob-grounded attention layers and a plurality of U-Net layers.

7. The computer-implemented method of claim 6, wherein each of the blob-grounded attention layers comprise a masked cross attention layer that is connected to a U-Net layer of the plurality of U-Net layers, and wherein inputting the blob representation into the blob-grounded text-to-image diffusion model to generate the output image comprises:
generating visual tokens based on providing a blob representation embedding to the masked cross attention layer; and
providing the generated visual tokens to the U-Net layer to guide the U-Net layer in generating the output image.

8. The computer-implemented method of claim 7, wherein inputting the blob representation into the blob-grounded text-to-image diffusion model to generate the output image further comprises:
performing a Fourier feature encoding to encode the blob parameter into a blob parameter embedding;
inputting the blob description into a text encoder to generate a blob sentence embedding; and
concatenating the blob parameter embedding and the blob sentence embedding to generate the blob representation embedding.

9. The computer-implemented method of claim 7, wherein inputting the blob representation into the blob-grounded text-to-image diffusion model to generate the output image further comprises:
generating an attention mask that attends to a subset of a plurality of pixels based on the subset of the plurality of pixels being within a blob ellipse that is defined by the blob parameter, and
wherein generating the visual tokens comprises generating, by the masked cross attention layer, the visual tokens based on the blob representation embedding attending to only the subset of the plurality of pixels that are within the blob ellipse being defined by the blob parameter.

10. The computer-implemented method of claim 1, further comprising:
obtaining a request to generate the output image, wherein the request comprises a user prompt, and
wherein obtaining the blob representation comprises:
generating the blob parameter and the blob description based on inputting the user prompt into one or more large language models (LLMs).

11. The computer-implemented method of claim 10, wherein generating the blob parameter and the blob description based on inputting the user prompt into the one or more LLMs comprises:
generating a first system prompt for the blob parameter using the user prompt;
generating a second system prompt for the blob description using the user prompt; and
providing the first system prompt and the second system prompt to the one or more LLMs to generate the blob parameter and the blob description.

12. The computer-implemented method of claim 1, wherein at least one of the steps of obtaining and inputting are performed on a server or in a data center to generate the output image, and the output image is streamed to a user device.

13. The computer-implemented method of claim 1, wherein at least one of the steps of obtaining and inputting are performed within a cloud computing environment.

14. The computer-implemented method of claim 1, wherein at least one of the steps of obtaining and inputting are performed for training, testing, or certifying a neural network employed in a machine, robot, or autonomous vehicle.

15. The computer-implemented method of claim 1, wherein at least one of the steps of obtaining and inputting is performed on a virtual machine comprising a portion of a graphics processing unit.

16. A system for using a blob-grounded text-to-image diffusion model to generate images,
comprising:
one or more processors; and
a non-transitory computer-readable medium having processor-executable instructions stored thereon, wherein the processor-executable instructions, when executed by the one or more processors, facilitate:
obtaining a blob representation for an object to be generated within an output image, wherein the blob representation comprises a blob parameter and blob description, wherein the blob parameter indicates a plurality of variables that define an ellipse for the object and the blob description indicates a textual description of the object; and
inputting the blob representation into the blob-grounded text-to-image diffusion model to generate the output image.

17. The system of claim 16, wherein the processor-executable instructions, when executed by the one or more processors, further facilitate:
training the blob-grounded text-to-image diffusion model using training data comprising a training image and one or more training models.

18. The system of claim 17, wherein training the blob-grounded text-to-image diffusion model comprises:
inputting the training image into an open vocabulary segmentation model to generate one or more training blob parameters;
inputting the one or more training blob parameters and the training image into a vision language model to generate one or more training blob descriptions;
inputting the one or more training blob parameters and the one or more training blob descriptions into the blob-grounded text-to-image diffusion model to generate a training output image; and
training the blob-grounded text-to-image diffusion model based on comparing the training output image with the training image.

19. A non-transitory computer-readable medium having processor-executable instructions stored thereon, wherein the processor-executable instructions, when executed, facilitate:
obtaining a blob representation for an object to be generated within an output image, wherein the blob representation comprises a blob parameter and blob description, wherein the blob parameter indicates a plurality of variables that define an ellipse for the object and the blob description indicates a textual description of the object; and
inputting the blob representation into a blob-grounded text-to-image diffusion model to generate the output image.

20. The non-transitory computer-readable medium of claim 19, wherein the processor-executable instructions, when executed, further facilitate:
training the blob-grounded text-to-image diffusion model using training data comprising a training image and one or more training models.
